(19) United States
(12) Patent Application Publication
(10) Pub. No.: US 2026/0211514 A1
(43) Pub. Date: Jul. 23, 2026

(54) Capacitive Sensing Knob Apparatus and Touch Sensitive Processing Apparatus Thereof and Touch System

(71) Applicant: EGALAX_EMPIA TECHNOLOGY INC., Taipei City (TW)

(72) Inventors: CHIN-FU CHANG, Taipei City (TW); SHANG-TAI YEH, Taipei City (TW)

(21) Appl. No.: 19/449,492

(22) Filed: Jan. 15, 2026

Related U.S. Application Data
(60) Provisional application No. 63/747,778, filed on Jan. 21, 2025.

(30) Foreign Application Priority Data
Jul. 14, 2025 (TW) 114126508

(51) Int. Cl. G06F 3/0362; G06F 3/038; G06F 3/041; G06F 3/044

(52) U.S. Cl. CPC G06F 3/0362; G06F 3/038; G06F 3/04164; G06F 3/044

(57) ABSTRACT

A detecting method of an input apparatus, wherein the input apparatus including an input electrode, a driving electrode, and multiple sensing electrodes which are not in contact with others, a part of the input electrode simultaneously covering the driving electrode and one or two sensing electrodes, wherein the detecting method comprising: transmitting driving signals from the driving electrode; simultaneously sensing the induced driving signals via the sensing electrodes to get multiple signal strength values, respectively; and determining a position of the part with respect to the multiple sensing electrodes according to the signal strength values.

### CROSS REFERENCE TO RELATED PATENT APPLICATION

This patent application claims benefits of a U.S. provisional Ser. No. 63/747,778, filed on Jan. 21, 2025, and is further based on a Taiwan, R.O.C. patent application No. 114126508 filed on Jul. 14, 2025.

### FIELD OF THE INVENTION

The present application is related to input apparatus, especially related to capacitive sensing touch knob and slider.

### BACKGROUND OF THE INVENTION

Knob and slider are common control components of control panel. Traditional knob and slider have moving parts for electric coupling. The moving parts are prone to wear and tear, and therefore failure. Hence, it exists a need for capacitive sensing touch knob and slider which does not have electrical contact part to improve lifetime.

### SUMMARY OF THE INVENTION

An objective of the present invention is to provide a capacitive sensing knob mechanism and a capacitive sensing slider mechanism with no electrical contact parts.

According to an embodiment of the present application, a detecting method of an input apparatus is provided. The input apparatus including an input electrode, a driving electrode, and multiple sensing electrodes which are not in contact with others, a part of the input electrode simultaneously covering the driving electrode and one or two sensing electrodes, wherein the detecting method comprising: transmitting driving signals from the driving electrode; simultaneously sensing the induced driving signals via the sensing electrodes to get multiple signal strength values, respectively; and determining a position of the part with respect to the multiple sensing electrodes according to the signal strength values.

According to an embodiment of the present application, a capacitive sensing knob apparatus is provided. The capacitive sensing knob apparatus, comprising: a knob electrode area, which comprises: multiple first ring electrodes, which are disposed at a circumference of a first circle evenly, area sizes of each the first ring electrodes are identical, shapes of each the first ring electrodes are similar and pointing to a center of the first circle; and a second ring electrode, which is disposed at a circumference of a second circle, wherein the first circle and the second circle are concentric circles; and a knob which is rotatable around the center, wherein the knob comprises a first knob electrode, when the knob is oriented to a first angle, the first knob electrode simultaneously covers parts of the two adjacent first ring electrodes and a part of the second ring electrode.

According to an embodiment of the present application, a capacitive sensing slider apparatus is provided. The capacitive sensing slider apparatus, comprising: a slider electrode area, comprises multiple sensing slider electrodes in parallel to an axis, area sizes of each the sensing slider electrodes are identical, distances between any two adjacent sensing slider electrodes are identical; a driving slider electrode in parallel to the multiple sensing slider electrodes; and a slider above the slider electrode area, positions of slider being selectively set are in parallel to the axis, the slider comprises a slider electrode, when the slider electrode is at a first position, the slider electrode simultaneously covers parts of two adjacent sensing slider electrodes and a part of the driving slider electrode.

According to an embodiment of the present application, a touch sensitive processing apparatus applicable to capacitive sensing knob apparatus is provided. The touch sensitive processing apparatus, comprising: an interconnection network module, configured for connecting the multiple first ring electrodes and the second ring electrode; a sensing circuit module, configured for connecting to the first ring electrodes via the interconnection network module; a driving circuit module, configured for connecting to the second ring electrode via the interconnection network module; and a processor module, configured for executing instructions stored in non-volatile memory to realize following steps: having the driving circuit module transmit driving signals to the second ring electrode; having the sensing circuit module sense the driving signals induced by the first ring electrodes to generate sensed values, respectively; calculating an orientation angle of the knob according to the sensed values; and reporting the orientation angle of the knob to a host.

According to an embodiment of the present application, a touch sensitive processing apparatus applicable to capacitive sensing slider apparatus is provided. The touch sensitive processing apparatus, comprising: an interconnection network module, configured for connecting the multiple sensing slider electrodes and the driving slider electrode; a sensing circuit module, configured for connecting the sensing slider electrodes via the interconnection network module; a driving circuit module, configured for connecting the driving slider electrode via the interconnection network module; and a processor module, configured for executing multiple instructions stored in a non-volatile memory to realize following steps: having the driving circuit module provide driving signals to the driving slider electrode; having the sensing circuit module sense the driving signals induced by the sensing slider electrodes to generate multiple sensed values, respectively; calculating a position of the slider based on the multiple sensed values; and reporting the position of the slider to a host.

According to an application of the present application, a touch system is provided. The touch system comprising the touch sensitive processing apparatus and the capacitive sensing knob apparatus.

According to an application of the present application, a touch system is provided. The touch system comprising the touch sensitive processing apparatus and the capacitive sensing slider apparatus.

The capacitive sensing knob apparatus and the capacitive sensing slider apparatus provided by the present application remove moving parts for electrically contact. Thus, the apparatuses would not fail due to the wear of the moving parts. Lifetime of these apparatuses can be extended as a result. Besides, the touch sensitive processing methods and apparatus provided by the present application can calculate the orientation angle of the capacitive sensing knob apparatus and the position of the capacitive sensing slider apparatus precisely according to mutual capacitive sensing principles.

### BRIEF DESCRIPTION OF THE DRAWINGS

The advantages and spirit related to the present invention can be further understood via the following detailed description and drawings.

FIG. 1 shows a block diagram of a touch system 9900 in accordance with an embodiment of the present application.

FIG. 2 shows a top view of a knob electrode area 100 in accordance with an embodiment of the present application.

FIG. 3 shows a sectional diagram of a knob and its corresponding knob electrode area 100 in accordance with an embodiment of the present application.

FIG. 4 depicts a top view of the knob electrode 310 in accordance with an embodiment of the present application.

FIG. 5 depicts a diagram of the knob 300 and the knob electrode area 100.

FIG. 6A shows a diagram of sensed signals and corresponding angles in accordance with an embodiment of the present application.

FIG. 6B depicts an experimental result of sensed signals and corresponding angles in accordance with an embodiment of the present application.

FIG. 7 depicts a top view of a knob electrode area 100 in accordance with another embodiment of the present application.

FIG. 8 depicts a top view of a knob 300 in accordance with another embodiment of the present application.

FIG. 9 depicts a diagram of signals and angles in accordance with another embodiment of the present application.

FIG. 10 depicts a top view of a knob electrode area 1000 in accordance with another embodiment of the present application.

FIG. 11 depicts a top view of a knob 1100 in accordance with another embodiment of the present application.

FIG. 12, which depicts a top view of a knob electrode area 1200 in accordance with another embodiment of the present application.

FIG. 13 illustrates a diagram of a knob electrode 1310 and the knob electrode area 1200 in accordance with another embodiment of the present application.

FIG. 14 illustrates a top view of a knob electrode area 1400 in accordance with another embodiment of the present application.

FIG. 15 illustrates a diagram of the knob electrode 1310 and the knob electrode area 1400 in accordance with an embodiment of the present application.

FIG. 16 illustrates a sectional diagram of the knob electrode 310, the driving knob electrode 110, and the sensing knob electrode 120-1 in accordance with an embodiment of the present application.

FIG. 17 illustrates another sectional diagram of the knob electrode 310, the driving knob electrode 110, and the sensing knob electrode 120-1 of the embodiment as shown in FIG. 16.

FIG. 18 illustrates another sectional diagram of the knob electrode 310, the driving knob electrode 110, and the sensing knob electrode 120-1 in the embodiment as shown in FIG. 17.

FIG. 19 illustrates a sectional diagram of the knob electrode 1310, the driving knob electrode 110, the sensing knob electrode 120-1, and the third ring electrode 1230 in the embodiment as shown in FIG. 14.

FIG. 20A illustrates a sectional diagram of the knob electrode 310, the driving knob electrode 110, and the sensing knob electrode 120-1 in the embodiment as shown in FIG. 3.

FIG. 20B illustrates a variant of the embodiment as shown in FIG. 20A.

FIG. 21 illustrates a sectional diagram of the knob electrode 1310, the driving knob electrode 110, the sensing knob electrode 120-1, and the third ring electrode 1440-1 in the embodiment as shown in FIG. 15.

FIG. 22 depicts a top view of a slider electrode area 2200 according to an embodiment of the present application.

FIG. 23 depicts a variant of the slider electrode area 2200 of the embodiment as shown in FIG. 22.

FIG. 24A illustrates a top view of the slider electrode area 2200 as shown in FIG. 22 which is covered by a slider electrode 2410A.

FIG. 24B illustrates a top view of the slider electrode area 2200 as shown in FIG. 22 which is covered by another slider electrode 2410B.

FIG. 25A illustrates a top view of the slider electrode area 2200 as shown in FIG. 23 which is covered by a slider electrode 2510A.

FIG. 25B illustrates a top view of the slider electrode area 2200 as shown in FIG. 23 which is covered by another slider electrode 2510B.

FIG. 26 illustrates a block diagram of a touch system 2600 in accordance with an embodiment of the present application.

FIG. 27 is a touch sensitive processing method 2700 applicable to capacitive sensing knob device in accordance with an embodiment of the present application.

FIG. 28 depicts a flowchart diagram of a touch sensitive processing apparatus 2800 applicable to capacitive sensing knob apparatus in accordance with an embodiment of the present application.

FIG. 29 depicts a flowchart diagram of a touch sensitive processing apparatus 2900 applicable to capacitive sensing slider apparatus in accordance with an embodiment of the present application.

### DETAILED DESCRIPTION OF THE PREFERRED EMBODIMENT

The terms “first”, “second”, “third”, etc. (if any) in the description and scope of the patent application and the drawings of this application are used to distinguish similar objects and are not necessarily used to describe a specific order or sequence. It should be understood that the objects described in such manner can be interchanged under appropriate circumstances. In the description of this application, “plurality” means two or more, unless otherwise expressly and specifically limited. In addition, the terms “including” and “having” and any variations thereof are intended to cover non-exclusive inclusions. Some of the blocks shown in the drawings are functional entities and do not necessarily correspond to physically or logically independent entities. Such functional entities can be implemented in software form, or in one or more hardware circuits or integrated circuits, or in different networks and/or processor devices and/or microcontroller devices.

In the description of this application, it should be noted that, unless otherwise specified or limited, the terms “mounted,” “connected,” and “connected” should be understood in a broad sense. For example, they can refer to fixed connections, detachable connections, or integral connections; they can refer to mechanical connections, electrical connections, or mutual communication; they can refer to direct connections, indirect connections through an intermediate medium, and internal connections between two components or interactions between two components. A person skilled in the art will understand the specific meanings of the aforementioned terms in this application based on the specific circumstances.

In order to make the purpose, features and advantages of this application more obvious and easy to understand, this application is further described in detail below with reference to the drawings and specific implementation methods.

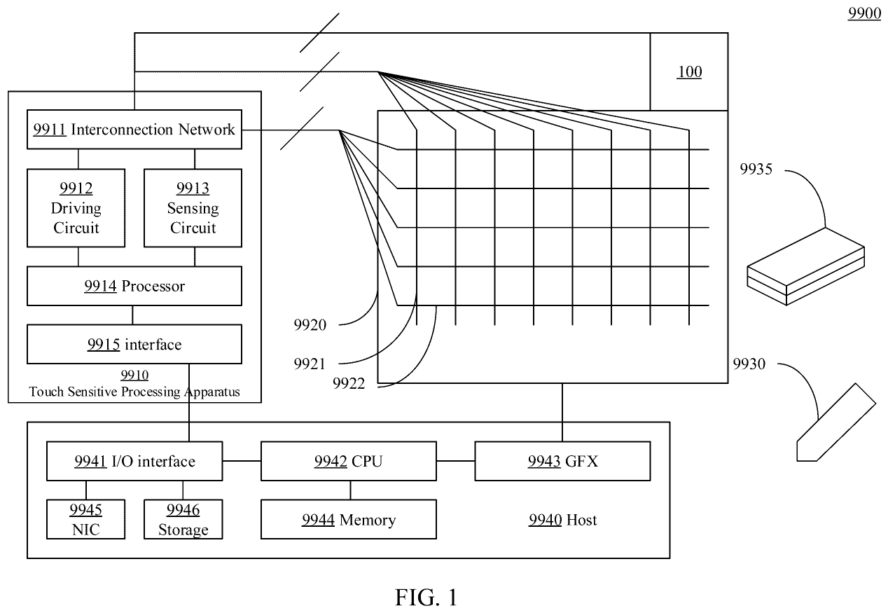

Please refer to FIG. 1, which shows a block diagram of a touch system 9900 in accordance with an embodiment of the present application. The touch system 9900 may be common desktop, laptop, tablet computers, industrial control computers, smartphones or any other kind of computers having touch sensitive functionality.

The touch system 9900 may comprise a touch sensitive processing apparatus 9910, a touch panel or screen 9920 connected to the touch sensitive processing apparatus, and a host 9940 connected to the touch sensitive processing apparatus. The touch system 9900 may further comprises one or more styli 9930 and/or touch board erasers 9935. In the following specification of the present application, the touch panel or screen 9920 may be referred to as touch screen 9920. However, in the embodiment lack of display functionality, person having ordinary skill in the art can understand that the touch screen as recited is touch panel.

The touch screen 9920 may comprise multiple first electrodes 9921 in parallel to a first axis and multiple second electrodes 9922 in parallel to a second axis. The first electrodes 9921 may intersect with the second electrodes 9922 in order to form multiple sensing points or sensing areas. Equivalently, the second electrodes 9922 may intersect with the first electrodes 9921 in order to form multiple sensing points or sensing areas. In some embodiments of the present application, the first electrodes 9921 may be referred as first touch electrodes 9921 and the second electrodes 9922 may be referred as second touch electrodes 9922. The first electrodes 9921 and the second electrodes 9922 may be collectively referred as touch electrodes. In some embodiments, the first electrodes 9921 and the second electrodes 9922 are made by transparent material. When applicable to the touch screen 9920 of some embodiments, the first electrodes 9921 and the second electrodes 9922 may be disposed in one electrode layer. Conductive plates of each one of the first electrodes 9921 or the second electrodes 9922 may be connected by bridging. The first electrodes 9921 and the second electrodes 9922 may be disposed at different overlapping electrode layers. Unless described specifically, the present application may be applied to the embodiments having one or more electrode layers. The first axis and the second axis are perpendicular in most cases. However, the present application does not limit that the first axis and the second axis are perpendicular. In one embodiment, the first axis may be a horizontal axis or a pixel refreshing axis of the touch screen 9920.

The touch sensitive processing apparatus 9910 may comprise following hardware circuit: an interconnection network module 9911, a driving circuit module 9912, a sensing circuit module 9913, a processor module 9914, and an interface module 9915. The touch sensitive processing apparatus 9910 may be implemented inside a single integrated circuit which may include one or more chips. It may use multiple integrated circuits and an interconnected circuit board carried the multiple integrated circuits to realize the touch sensitive processing apparatus 9910. The touch sensitive processing apparatus 9910 may be implemented in single integrated circuits with the host 9940. The present application does not limit how to implement the touch sensitive processing apparatus 9910.

The interconnection network module 9911 is configured to connect each of the multiple first electrodes 9921 and/or the multiple second electrodes 9922 of the touch screen 9920. The interconnection network module 9911 may follow control command of the processor module 9914 for connecting the driving circuit module 9912 and any one or more touch electrodes and for connecting the sensing circuit module 9913 and any one or more touch electrodes. The interconnection network module 1211 may include a combination of one or more multiplexers (MUX) to realize functions.

The driving circuit module 9912 may comprise clock generator, frequency divider, frequency multiplier, phase lock loop, power amplifier, DC-DC voltage converter, regulator and/or filter, which is configured to provide driving signal to any one or more touch electrodes via the interconnection network module 9911 according to control commands of the processor module 9914. The driving signal may be modulated by kinds of analog or digital modulations for carrying some messages. The modulations include but not limit to frequency modulation (FM), phase modulation, amplitude modulation, dual sideband modulation (DSB), single sideband module (SSB-AM), vestigial sideband modulation, amplitude shift keying (ASK), phase shift keying (PSK), quadrature amplitude modulation (QAM), frequency shift keying (FSK), continuous phase modulation (CPM), code division multiple (CDMA), time division multiple access (TDMA), orthogonal frequency division multiplexing (OFDM), pulse width modulation (PWM) and etc. The driving signal may include one or more square waves, sinuous waves or any modulated waves. The driving circuit module 9912 may include one or more channel. Each channel may be connected to any one or more touch electrodes via the interconnection network module 9911.

The sensing circuit module 9913 may comprise integrator, sampler, clock generator, frequency divider, frequency multiplier, phase lock loop, power amplifier, operational amplifier, multiplier, DC-DC voltage converter, regulator and/or filter, which is configured to sense on any one or more touch electrodes and second button electrodes via the interconnection network module 9911 according to control commands of the processor module 9914. When the touch signal is transmitted from one of the touch electrodes, another touch electrode may induce the touch signal. And the sensing circuit module 9913 may demodulate the induced touch signal by another touch electrode in accordance with the modulation method performed on the driving signal by the driving circuit module 9912 in order to restore the messages carried by the driving signal. The sensing circuit module 9913 may include one or more channels. Each channel may be connected to any one or more touch electrodes via the interconnection network module 9911. At the same time, each channel may simultaneously perform sensing and demodulation.

In one embodiment, the driving circuit module 9912 and the sensing circuit module 9913 may include analog front-end (AFE) circuits. In another embodiment, in additional to the AFE circuits, the driving circuit module 9912 and the sensing circuit module 9913 may include digital back-end (DBE) circuits. If the driving circuit module 9912 and the sensing circuit module 9913 include only the AFE circuits, the DBE circuits may be implemented in the processor module 9914.

The processor module 9914 may include a digital signal processor for connecting the AFE circuits or the DBE circuits of the driving circuit module 9912 and the sensing circuit module 9913, respectively. The processor module 9914 may include an embedded processor, non-volatile memories and volatile memories. Normal or real-time operating system (OS) and their application programs may be stored in the non-volatile memories. The OS and the application programs include multiple instructions and data. The processor (including the embedded processor and the digital signal processor) may execute the instructions for controlling other modules including the interconnection network module 9911, the driving circuit module 9912, the sensing circuit module 9913 and the interface module 9915 of the touch sensitive processing apparatus 9910. For examples, the processor module 9914 may comprises processors widely adopted in the industry such as 8051 series, Intel i960 series, ARM Cortex-M series and etc. The present application does not limit types and numbers of processor cores included in the processor module 9914.

The instructions and data may be used to implement each of steps mentioned in the present application and flows and methods constructed by the steps. Some instructions may be executed independently inside the processor module 9914, for examples, arithmetic and log operation instructions. Other instructions may be used to control other circuits of the touch sensitive processing apparatus 9910. These instructions may include input/output interfaces of the processor module 9914 to control other circuits. Other circuits may provide information via the input/output interface of the processor module 9914 to the OS and/or application programs executed by the processor module 9914. Persons having ordinary skill in the art should have common knowledge of computer organization and architecture which enabling them to understand that the flows and methods provided by the present application can be realized by the circuits and the instructions.

The interface module 9915 may include kinds of serial or parallel bus, such as universal serial bus (USB), I²C, peripheral component interconnect (PCI), PCI-Express, IEEE 1394 and other industrial standard input/output interface. The touch sensitive processing apparatus 9910 connects to the host 9940 via the interface module 9915.

The touch system 9900 may comprise one or more styli 9930 and/or touch board erasers 9935. The stylus 9930 and touch board eraser 9935 may be transmitters which emit electrical signals. The transmitters may include active transmitter which actively emits electrical signals or passive transmitters which emit electrical signals in response to external electrical signals. The stylus 9930 and touch board eraser 9935 may comprise one or more electrodes which is configured to receive electrical signals from the touch screen 9920 synchronously or asynchronously, or to transmit electrical signals to the touch screen 9920 synchronously or asynchronously. The electrical signals may be modulated according to one or more of the aforementioned modulation methods.

The stylus 9930 or touch board eraser 9935 may be conductor which is configured to transmit driving signals or to be grounded via user's hand or body. The stylus 9930 or touch board eraser 9935 may be physically or wirelessly connected to an I/O interface 9941 of the host 9940 or any other interfacing circuits of the I/O interface 9941.

The touch sensitive processing apparatus 9910 may detect one or more external objects such as fingers, palms, or passive styli 9930 or touch board erasers 9935, or active styli 9930 or touch board erasers 9935 emitting electrical signals via the touch screen 9920. The touch sensitive processing apparatus 9910 may utilize mutual-capacitance sensing or self-capacitance sensing to detect external conductive objects. The styli 9930 or touch board erasers 9935 and touch sensitive processing apparatus 9910 may use the aforementioned modulation and demodulation methods to transmit message via the electrical signals. The touch sensitive processing apparatus 9910 may detect one or more positions where the styli 9930 or touch board erasers 9935 touch or approach the touch screen 9920, status or sensors (pressure sensor or button) onboard the stylus 9930 or touch board eraser 9935, orientation angle or inclination angle of the stylus 9930, or touch board eraser 9935 with respect to the touch screen 9920 etc. according to the electrical signals.

The host 9940 is a main apparatus for controlling the touch system 9900. It may comprise an input/output interface module 9941 for connecting the interface module 9915, a central processing unit (CPU) module 9942, a graphics processor module 9943, a memory module 9944 connects to the CPU module 9942, a network interface module 9945 and a storage module 9946 connecting to the input/output interface module 9941.

The storage module 9946 comprises non-volatile memory. Common examples are hard disks, electronic erasable rewritable read only memory (EEPROM), or flash memory. The storage module 9946 may store normal operating system and application programs executable under the operating system. The network interface module 9945 may comprise wired or wireless hardware network interface. The network interface module 9945 may be compliant to common industrial standards such as IEEE 802.11 Wireless Local Area Network, IEEE 802.3 Local Area Network, 3G, 4G and/or 5G wireless telecommunication standards, Bluetooth wireless communication standards, etc.

The CPU module 9942 may directly or indirectly connects to the input/output interface module 9941, the graphics processor module 9943, the memory module 9944, the network interface module 9945 and the storage module 9946. The CPU module 9942 may comprise one or more processor or processor cores. Common processors may include Intel, AMD, VIA's x86 and x64 instruction set architecture (ISA) processors, Apple, Qualcomm, MediaTek's ARM ISA processors, or any other types of complex instruction set computer (CISC) or reduced instruction set computer (RISC) processors. The OS and application programs include multiple instructions and data corresponding to the instruction set. By executing these instructions, the CPU module 9942 is able to control other circuits of the touch system 9900.

The optional graphics processor (GPU) module 9943 is usually configured to handle computations with respect to graphics outputs. The graphics processor module 9943 may connect to the touch screen 9920 for controlling outputs of the touch screen 9920. In some applications, the host 9940 may have the CPU module 9942 execute the computations with respect to graphics outputs, without dedicated handling of the graphics processor module 9943.

The host 9940 may comprise components or apparatus not shown in FIG. 1, for example, audio input/output interface, keyboard input interface, mouse input interface, track-ball input interface and/or any other hardware circuits. Persons having ordinary skill in the art should have common knowledge of computer organization and architecture. They can understand the electronic system 9900 disclosed by the present application is exemplary. Parts regarding to the inventive feature provided by the present application should be referred to the specification and the claims.

As shown in FIG. 1, besides the touch screen 9920, there further exists at least one knob electrode area 100. The knob electrode area 100 may be placed besides the touch screen 9920 or other place of the touch system 9900. The touch sensitive processing apparatus 9910 can connect to multiple knob electrodes via the interconnection network module 9911 and multiple conductive wires, respectively.

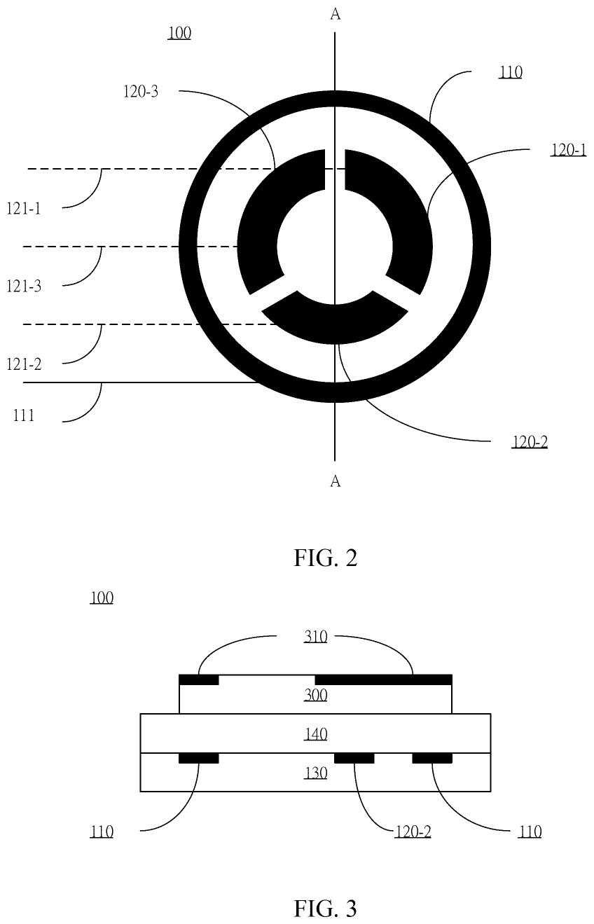

Please refer to FIG. 2, which shows a top view of a knob electrode area 100 in accordance with an embodiment of the present application. The knob electrode area 100 may comprise two concentric electrode patterns. The outer concentric pattern is a driving knob electrode 110. The driving circuit module 9912 can connect to the driving knob electrode 110 via the interconnection network module 9911 for emitting driving signals. Inner concentric pattern comprises multiple sensing knob electrodes. As shown in FIG. 2, there are three sensing knob electrodes 120-1 through 120-3.

In one embodiment, each of the sensing knob electrodes has identical area size. In one embodiment, each of the sensing knob electrodes has identical shape with different orientations. In one embodiment, distances between each of the sensing knob electrodes and the driving knob electrode are identical.

In one embodiment, the multiple sensing knob electrodes and the driving knob electrode 110 are located in the same layer. For example, they may be co-located in the same layer of the first electrodes 9921 of the touch screen 9920. Or they may be co-located in the same layer of the second electrodes 9922 of the touch screen 9920. The driving knob electrode 110 may connect to the interconnection network module 110 via a conductive wire 111. The three sensing knob electrodes 120-1 through 120-3 may connect to the interconnection network module 110 via conductive wires 121-1 through 121-3, respectively. The conductive wires 121-1 through 121-3 may be located in a layer different from the layer where the sensing knob electrodes and the driving knob electrode 110 located.

In one embodiment, the sensing knob electrodes and the driving knob electrode 110 may be located in different layers. For example, the driving knob electrode 110 may be co-located in the same layer with the first electrodes 9921 of the touch screen 9920. The sensing knob electrodes may be co-located in the same layer with the second electrodes 9922. Reversely, in another embodiment, the driving knob electrode 110 may be co-located in the same layer with the second electrodes 9922 of the touch screen 9920. The sensing knob electrodes may be co-located in the same layer with the first electrodes 9921. The conductive wires 121-1 through 121-3 may be co-located in the same layer of the sensing knob electrodes; the conductive wire 111 may be co-located in the same layer where the driving knob electrode 110 resides.

In one embodiment, the material of the sensing knob electrodes and the driving knob electrode 110 may be identical to the first electrodes 9921 or the second electrodes 9922. In one embodiment, a substrate supporting the sensing knob electrodes and the driving knob electrode 110 may be the same substrate of the touch screen 9920. However, person having ordinary skill in the art can understand that the features may be applicable to some embodiments merely. The features are not the limitations of the present invention.

Please refer to FIG. 3, which shows a sectional diagram of a knob and its corresponding knob electrode area 100 in accordance with an embodiment of the present application. The sectional diagram as shown in FIG. 3 may be corresponding to the AA line as shown in FIG. 2. The knob electrode area 100 may comprise sequentially a substrate 130 and a protection layer 140 on top of the substrate 130. The sensing knob electrodes and the driving knob electrode 110 may be located on the top surface or in the internal space of the substrate 130. As discussed, in one embodiment, the substrate 130 may be the same substrate of the touch screen 9920. The conductive wires 121-1 through 121-3 may be located on a bottom surface of the substrate 130. Circuits passing through the substrate 130 are configured to connect to the sensing knob electrodes. The conductive wire 111 may be located on the top surface of the or in the internal space of the substrate 130.

The protection layer 140 may be made of transparent material or non-transparent material. A knob 300 corresponding to the knob electrode area 100 is placed on top of the protection layer 140. The knob 300 comprises a conductive layer or a knob electrode 310. The knob electrode 310 is not in contact with the sensing knob electrodes and the driving knob electrode 110. The knob electrode 310 is configured to form at least one first capacitor with at least one of the sensing knob electrodes. The knob electrode 310 is configured to form a second capacitor with the driving knob electrode 110. When the knob 300 rotates, the touch sensitive processing apparatus 9910 can determine an orientation angle of the knob according to the capacitance difference of the at least one first capacitor.

Although there is no mechanism for fixing the knob 300 to the knob electrode area 100 as shown in FIG. 3, person having ordinary skill in the art can understand that a fastening mechanism including concentric ring may be used to place the knob 300 to a corresponding location of the knob electrode area 100. The rotational center of the knob 300 is at the central position of the knob electrode area 100. Moreover, although the knob electrode 310 is at the top of the knob 300, a printing layer, a graph or any other structures with visual mark can be added on top of the knob 300 so as that a user of the knob 300 is able to tell where the orientation angle the knob 300 points.

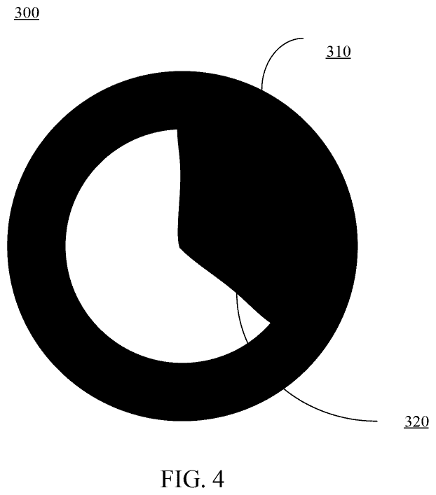

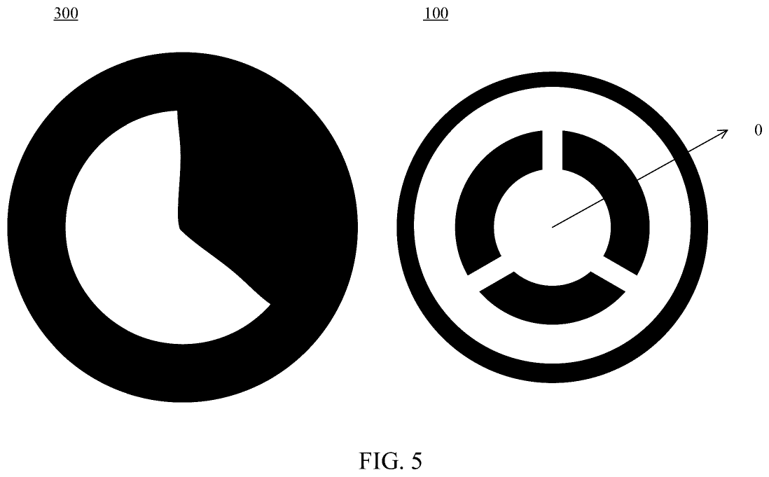

Please refer to FIG. 4, which depicts a top view of the knob electrode 310 in accordance with an embodiment of the present application. Please refer to FIG. 5, which depicts a diagram of the knob 300 and the knob electrode area 100. The knob electrode 310 may be treated as a circular ring for covering a part or all the driving knob electrode 110. The center of the circular ring is the rotational center of the knob 300. There is a fan part 320 inside the circular ring which is corresponding to one of the sensing knob electrodes. The fan part 320 may be configured to cover a part or all of one of the sensing knob electrodes.

In the embodiment as shown in FIG. 4, the knob electrode area 100 consists of three sensing knob electrodes. Therefore, the fanning angle of the fan part 320 is around 120 degrees. Because the distances between the sensing knob electrodes may be varied, the fanning angle of the fan part 320 may be varied accordingly so as the fan part 320 can be corresponding to one single sensing knob electrode.

Person having ordinary skill in the art can understand that when the knob electrode area 100 is composed of N sensing knob electrodes, the fanning angle of the fan part 320 may be around (360/N) degrees, where N is a positive integer larger than 1.

In addition, the fan part 320 may be designed in other shapes. For example, the fan part 320 may comprise a gap. The fan part 320 may have a missing corner near the rotational center. Person having ordinary skill in the art can understand the fan part 320 is primarily configured for forming the first capacitor with one of the sensing knob electrodes or two adjacent sensing knob electrodes. Hence the shape of the fan part 320 is not limited, as long as it can be corresponded to one or two adjacent sensing knob electrodes.

In one embodiment, in case that the fan part 320 is rotated so as it covers only one sensing knob electrode, the orientation angle of the knob 300 is set at an angle of 0 degrees. In the embodiment as shown in FIG. 5, in case the fan part 320 completely covers the sensing knob electrode 120-1, the orientation angle of the knob 300 is defined at an angle of 0 degrees. Person having ordinary skill in the art can understand that the angle of 0 degrees can be designated to any orientation angle. For convenience, in the embodiment as shown in FIG. 5, the orientation angle can be designated to align with a central line of the sensing knob electrode 120-1 corresponding to the rotational center.

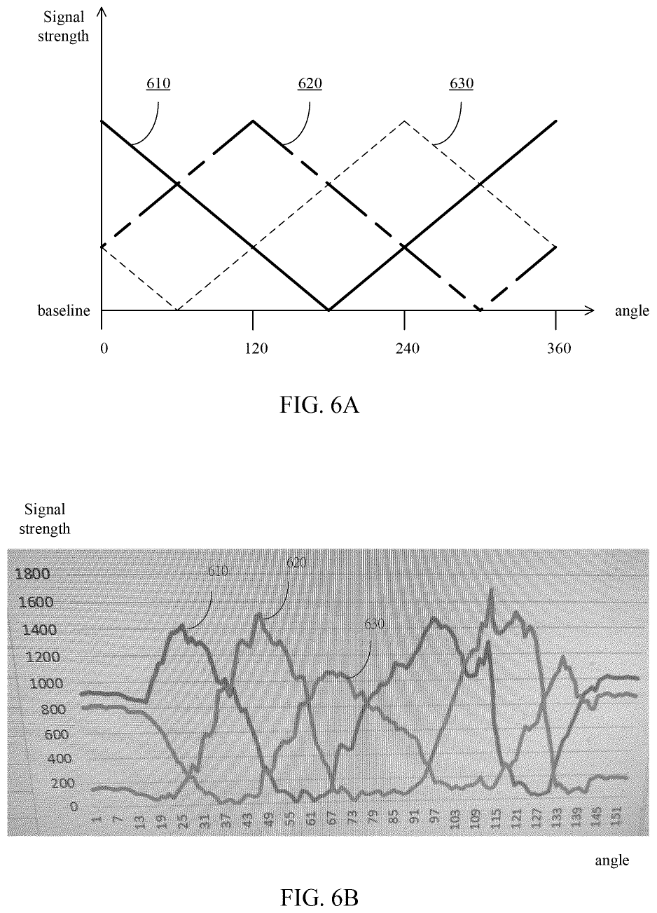

Please refer to FIG. 6A, which shows a diagram of sensed signals and corresponding angles in accordance with an embodiment of the present application. The embodiment as shown in FIG. 6A is corresponding to the knob 300 and the knob electrode area 100 as shown in FIG. 5. The vertical axis represents signal strengths. The horizontal axis represents the orientation angles of the knob, said 0-360 degrees. Signal 610 is the signal received by the sensing knob electrode 120-1, signal 620 is the signal received by the sensing knob electrode 120-2, and signal 630 is the signal received by the sensing knob electrode 120-3.

Please refer to FIG. 6B, which depicts an experimental result of sensed signals and corresponding angles in accordance with an embodiment of the present application. Analogously, the signal 610 is the signal received by the sensing knob electrode 120-1, the signal 620 is the signal received by the sensing knob electrode 120-2, and the signal 630 is the signal received by the sensing knob electrode 120-3. The signals 610~630 as shown in FIG. 6B are slightly different from the ideal situation as shown in FIG. 6A. The differences may be resulted from experimental interferences. However, the three signals as shown in FIG. 6B have more significant peaks. Person having ordinary skill in the art can consider that the ideal situation as shown in FIG. 6A is a calculation model. The orientation angle of the knob may be calculated according to the ideal situation as shown in FIG. 6A.

The driving circuit module 9912 of the touch sensitive processing apparatus 9910 transmits driving signals to the driving knob electrode 110 via the interconnection network module 9911 and the conductive wire 111. The driving signals may comprise sine waves or square waves, which can be modulated signals by any kind of the modulations. In one embodiment, the driving signals can be identical to the signals used by the touch sensitive processing apparatus 9910 for detecting an approaching or touching object on the touch screen 9920 so as the process complexity in demodulation can be reduced accordingly.

Via the second capacitor between the knob electrode 310 and the driving knob electrode 110, the driving signals are induced by the knob electrode 310. As a result, via the first capacitor(s) between the fan part and one or two sensing knob electrodes, the driving signals are induced by the one or two sensing knob electrodes. Through the corresponding conductive wires, the induced driving signals come back the sensing circuit module 9913 via the interconnection network module 9911. The sensing circuit module 9913 can detect the signal strengths of the induced by all the sensing knob electrodes.

Take an example, when the knob 300 orients to the angle of 0 degrees as shown in FIG. 5, because the fan part 320 only covers the sensing knob electrode 120-1, the signal 610 reaches its maximum. When the knob 300 rotates clockwise, the signal 620 corresponding to the sensing knob electrode 120-2 gradually grows, the signal 630 corresponding to the sensing knob electrode 120-3 attenuates gradually. Hence, the processor module 9914 of the touch sensitive processing apparatus 9910 is able to know that the knob 300 is rotating clockwise according to the variations of the signals 610 through 630. Reversely, when the knob 300 rotates counterclockwise, the signal 620 corresponding to the sensing knob electrode 120-2 gradually attenuates, the signal 610 corresponding to the sensing knob electrode 120-3 gradually amplified. Hence, the processor module 9914 of the touch sensitive processing apparatus 9910 can deduce that the knob 300 is rotating counterclockwise according to the variations of the signals 610 through 630.

In the embodiment as shown in FIG. 6A, an orientation angle of the knob 300 can be determined based on a combination of values of the signals 610 through 630. Take an example, when the knob 300 points to an angle of 60 degrees, the distance between the fan part 320 and the sensing knob electrode 120-3 is the largest, the signal 630 is at its minimum. Therefore, the processor module 9914 of the touch sensitive processing apparatus 9910 is able to determine that the orientation angle of the knob 300 points to 60 degrees. In another example, when the knob 300 points to 240 degrees, the fan part 320 fully covers the sensing knob electrode 120-3, the signal 630 is at its peak. Therefore, the processor module 9914 of the touch sensitive processing apparatus 9910 is able to determine that the orientation angle of the knob 300 points to 240 degrees.

In an embodiment as shown in FIG. 6A, the orientation angle of the knob 300 can be determined according to a ratio of two larger values of the three signals 610~630. For example, when the knob 300 orients to the angle of 60 degrees, the fan part 320 is the most distant to the sensing knob electrode 120-3, the signal 630 is at its minimum. Hence, the processor module 9914 of the touch sensitive processing apparatus 9910 can determine that the knob is oriented to the angle of 60 degrees according to a ratio of the signals 610 and 620. The ratio between the signals 610 and 620 is analogous to a ratio of the areas of the sensing knob electrode 120-1 and 120-2 which are covered by the knob electrode 310. Therefore, the calculated ratio between the signals 610 and 620 can be used to determine the ratio of the areas of the sensing knob electrode 120-1 and 120-2 which are covered by the knob electrode 310. In other words, the relative position of the knob electrode 310 corresponds to the sensing knob electrodes 120-1 and 120-2 can be determined. As a result, the orientation angle of the knob 300 is determined.

In an embodiment as shown in FIG. 6A, the signals 610~630 may be original signal values, or they may be difference values of original signal values and basis signal values. In some embodiments, the basis signal values corresponding to the signals 610~630 are identical. In another embodiment, the basis signal values corresponding to the signal values 610~630 are different, respectively, because the lengths of the conductive wires 120-1~120-3 are different.

The bases for determining the orientation angle, the rotational direction, and the rotational angular rate of the knob may be original signal values or difference values of original signal values and basis signal values. The processor module 9914 of the touch sensitive processing apparatus 9910 may report one or any combination of the orientation angle, the rotational direction, and the rotational angular rate of the knob to the host 9940.

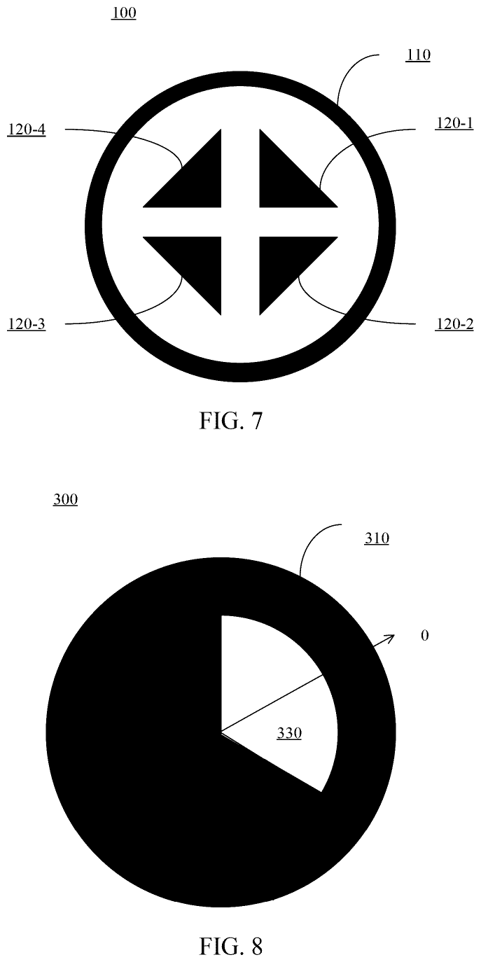

Please refer to FIG. 7, which depicts a top view of a knob electrode area 100 in accordance with another embodiment of the present application. Comparing with the knob electrode area 100 as shown in FIG. 2, the embodiment as shown in FIG. 7 includes four sensing knob electrodes 120-1~120-4 clock wisely. Except for the number is increased to four, the shape becomes perpendicular triangular. With respect to other inventive characteristics, the description of the embodiment as shown in FIG. 2 may be applied as references. Person having ordinary skill in the art can understand the knob electrode 310 corresponding to the knob electrode area 100 of the embodiment as shown in FIG. 7 includes a fan part 320 fanning around 360/4 degrees. No more description is elaborated here.

Please refer to FIG. 8, which depicts a top view of a knob 300 in accordance with another embodiment of the present application. Similar to the embodiment as shown in FIG. 4, the knob 300 corresponds to the knob electrode area 100 as shown in FIG. 2. The difference to the embodiment as shown in FIG. 4 is that a reverse fan part 330 as shown in FIG. 8 is corresponding to the fan part 320 as shown in FIG. 4. The reverse fan part 330 is hollow, without electrode.

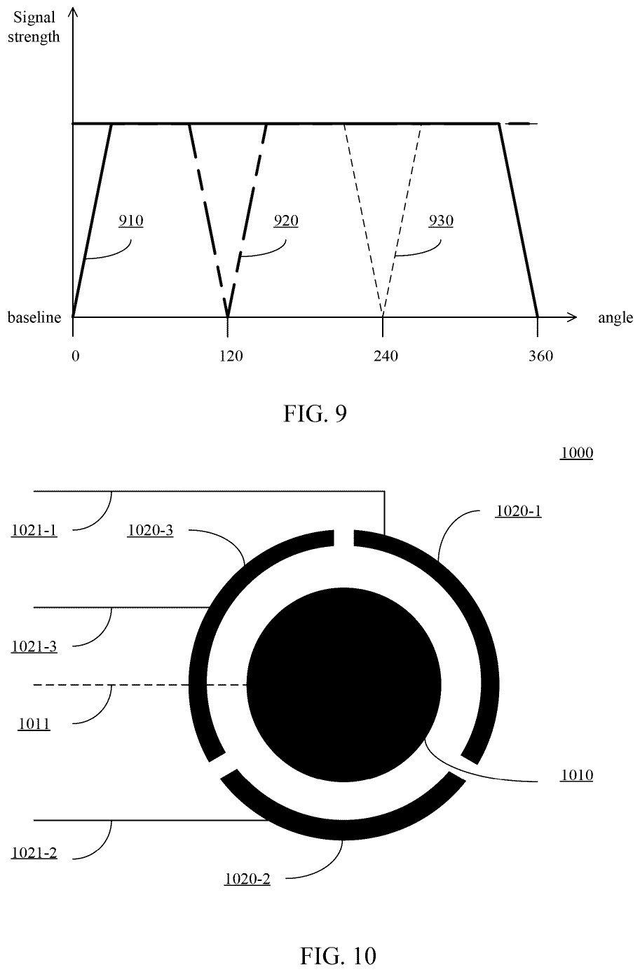

Please refer to FIG. 9, which depicts a diagram of signals and angles in accordance with another embodiment of the present application. The embodiment as shown in FIG. 9 is corresponding to the knob 300 as shown in FIG. 8 and the knob electrode area 100 as shown in FIG. 2. When the reverse fan part 330 points to 0 degrees, it covers all or a part of the sensing knob electrode 120-1. The second capacitor between the knob electrode 310 and the sensing knob electrode 120-1 shrinks to its minimum. Thus, the signal 910 corresponds to the sensing knob electrode 120-1 is at its minimum. Similarly, when the reverse fan part 330 points to 120 degrees, it covers all or a part of the sensing knob electrode 120-2. The second capacitor between the knob electrode 310 and sensing knob electrode 120-2 shrinks to its minimum. Thus, the signal 920 corresponds to the sensing knob electrode 120-2 is at its minimum. Similarly, when the reverse fan part 330 points to 240 degrees, it covers all or a part of the sensing knob electrode 120-3. The second capacitor between the knob electrode 310 and sensing knob electrode 120-3 shrinks to its minimum. Thus, the signal 930 corresponds to the sensing knob electrode 120-3 is at its minimum.

Please refer to FIG. 10, which depicts a top view of a knob electrode area 1000 in accordance with another embodiment of the present application. Similar to the knob electrode area 100 as shown in FIG. 2, the knob electrode area 1000 comprises two concentric electrodes. The difference is that the inner concentric electrode of the knob electrode area 1000 is the driving knob electrode 1010. And the outer concentric ring comprises N sensing knob electrodes. Although the driving electrode 1010 as shown in FIG. 10 is a solid circle, the driving knob electrode 1010 may be a circular ring, a regular M-gon, a regular M-edge ring etc., where M is a positive integer larger than 1.

The characteristics of the multiple sensing knob electrodes 120-1~120-3 as shown in FIG. 2 may be applicable to the multiple sensing knob electrodes 1020-1~1020-3 as shown in FIG. 10. For examples, the knob electrode area 1000 may comprise N sensing knob electrodes, where N is a positive integer larger than 1.

The multiple sensing knob electrodes 1020-1~1020-3 can connect to the interconnection network module 9911 of the touch sensitive processing apparatus 9910 via the conductive wires 1021-1~1021-3, respectively. The conductive wire 1011 can be used to connect to the interconnection network module 9911 of the touch sensitive processing apparatus 9910 and the driving knob electrode 1010. The characteristics of the conductive wires as shown in FIG. 2 can be applied to the conductive wires 1021-1~1021-3 and 1011 as shown in FIG. 10. For example, the conductive wires 1021-1~1021-3 may be disposed at the upper surface or the first surface of the substrate 130, the conductive wire 1011 may be disposed at the lower surface or the second surface opposite to the first surface of the substrate 130.

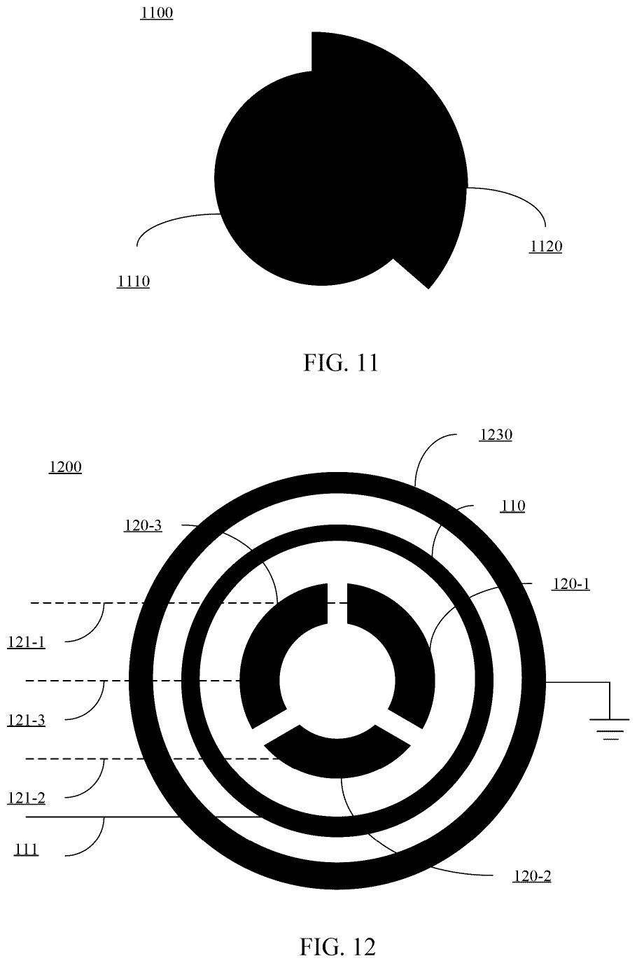

Please refer to FIG. 11, which depicts a top view of a knob 1100 in accordance with another embodiment of the present application. The knob 1100 is corresponding to the knob electrode area 1000 as shown in FIG. 10. The knob 1100 comprises a knob electrode 1110 which includes a solid inner circle and a fan part 1120 protruding the solid inner circle. The solid inner circle is corresponding to the driving knob electrode 1010. The protruding fan part 1120 can be corresponding to one or two of the sensing knob electrodes 1020-1~1020-3.

Person having ordinary skill in the art can understand the diagram of signals and angles as shown in FIG. 6A and corresponding description can be applied to the embodiments as shown in FIGS. 10 and 11. When the fan part 1120 points to 0 degrees, it covers all or a part of the sensing knob electrode 1020-1, the second capacitor between the knob electrode 1110 and the sensing knob electrode 1020-1 reaches its peak. Thus, the signal 610 corresponding to the sensing knob electrode 1020-1 would be at its maximum. Similarly, when the fan part 1120 points to 120 degrees, it covers all or a part of the sensing knob electrode 1020-2, the second capacitor between the knob electrode 1110 and the sensing knob electrode 1020-2 reaches its peak. Thus, the signal 620 corresponding to the sensing knob electrode 1020-2 would be at its maximum. Similarly, when the fan part 1120 points to 240 degrees, it covers all or a part of the sensing knob electrode 1020-3. The second capacitor between the knob electrode 1110 and the sensing knob electrode 1020-3 reaches its peak. Thus, the signal 620 corresponding to the sensing knob electrode 1020-3 would be at its maximum.

Analogously, in a variant of the knob 1100, a reverse fan part may exist similarly to the embodiment as shown in FIG. 8. The reverse fan part may be configured to cover one or two of the sensing knob electrodes. In case that the variant is applied to the embodiment as shown in FIG. 10, the corresponding diagram of signals and angles may be similar to the diagram as shown in FIG. 9.

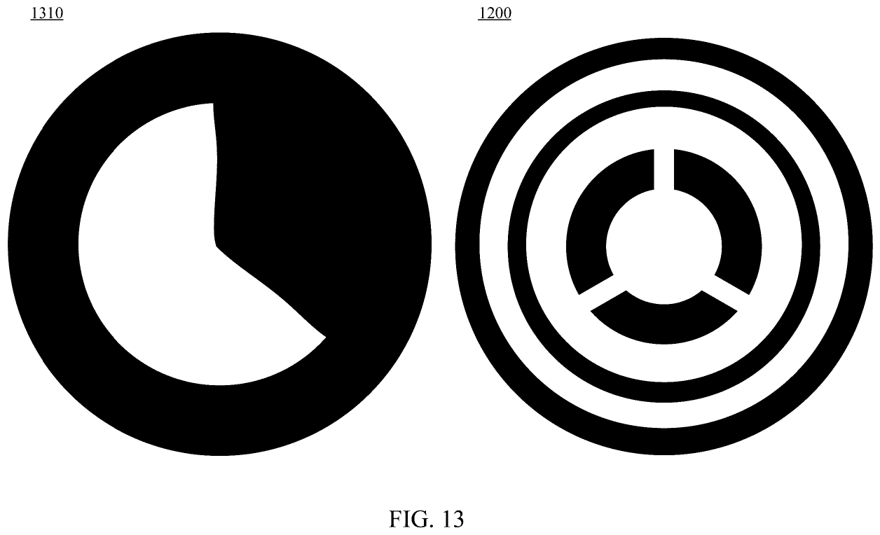

Please refer to FIG. 12, which depicts a top view of a knob electrode area 1200 in accordance with another embodiment of the present application. Comparing with the knob electrode area 100 as shown in FIG. 2, the knob electrode area 1200 further comprise a third ring electrode 1230 which is connected to a ground potential or a direct current voltage. The third ring electrode 1230 may comprise a full circular ring electrode, or alternatively multiple electrodes. The third ring electrode 1230 sequentially surrounds the driving knob electrode 110 and the multiple sensing knob electrodes 1120-1~1120-3. The third ring electrode 1230, the driving knob electrode 110, and the multiple sensing knob electrode 1120-1~1120-3 surround a common circular center.

Please refer to FIG. 13, which illustrates a diagram of a knob electrode 1310 and the knob electrode area 1200 in accordance with another embodiment of the present application. As shown in FIG. 13, the knob electrode 1310 covers on top of the corresponding knob electrode area 1200. The knob electrode 1310 and the knob electrode area 1200 share a common rotational axis. Wherever the knob points, the outer ring part of the knob electrode 1310 covers on top of the third ring electrode 1230 so as a capacitor between the knob electrode 1310 and the third ring electrode 1230 would be formed accordingly.

After the driving signals are emitted from the driving knob electrode 110, the driving signals induced by the knob electrode 1310 would be lost via the third ring electrode 1230 because the voltage potential of the third ring electrode 1230 is a ground potential or a DC voltage. Thus, the driving signals induced by the corresponding sensing knob electrode are reduced accordingly. As a result, the touch sensitive processing apparatus 9910 may have a better chance to detect the knob electrode 310 corresponding to the sensing knob electrode. In other words, the third ring electrode 1230 can increase sensitivity or signal-to-noise ratio.

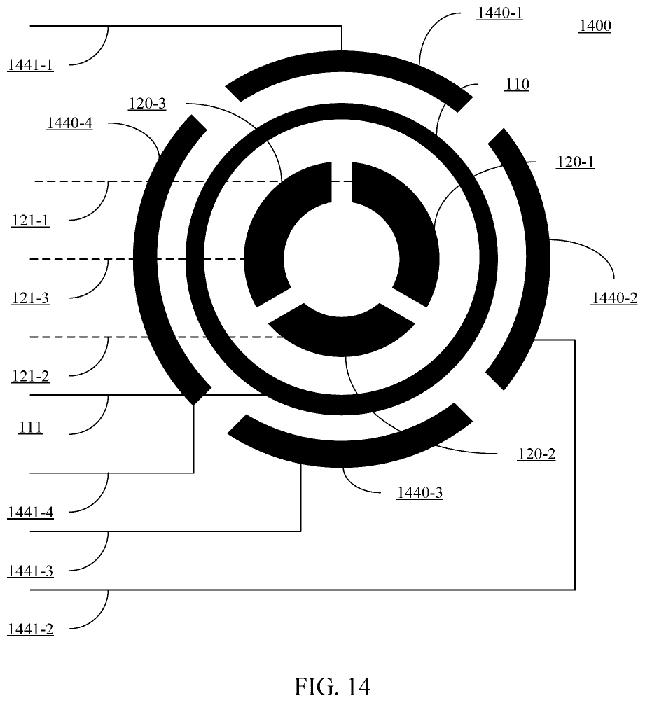

Please refer to FIG. 14, which illustrates a top view of a knob electrode area 1400 in accordance with another embodiment of the present application. Comparing with the embodiment as shown in FIG. 12, multiple third ring electrodes are included in the embodiment as shown in FIG. 14. Each the third ring electrodes are connected to the interconnection network module 9911 of the touch sensitive processing apparatus 9910, rather than the ground potential or the DC voltage. The embodiment as shown in FIG. 14 comprises four third ring electrodes 1440-1~1440-4 connects to the touch sensitive processing apparatus 9910 via the conductive wires 1441-1~1441-4, respectively.

Person having ordinary skill in the art can understand that the quantity of the third ring electrodes can be larger than or equals to 2. In the embodiment as shown in FIG. 14, the four third ring electrodes correspond to east, west, south, and north directions, respectively. For example, when the user presses the northern part of the knob, the knob electrode would get closer to the third ring electrode 1440-1 and farther to the third ring electrode 1440-3. As a result, the touch sensitive processing apparatus 9910 can detect variations of driving signals induced by these two third ring electrodes 1440-1 and 1440-3 via the conductive wires 1441-1 and 1441-3, respectively. In this example, because the distance between the third ring electrode 1440-1 and the knob electrode becomes shorter, their capacitance becomes larger. Reversely, the distance between the third ring electrode 1440-3 and the knob electrode becomes longer, their capacitance becomes smaller. Consequently, the sensed driving signals induced by the northern third ring electrode 1440-1 becomes larger, the sensed driving signals induced by the southern third ring electrode 1440-3 becomes smaller. The touch sensitive processing apparatus 9910 can determine that the knob electrode tilting toward north direction. The touch sensitive processing apparatus 9910 can report to the host 9940 that the user pressed the knob toward north direction.

In one embodiment, the touch sensitive processing apparatus 9910 can find one of the third ring electrodes with the largest signal variation or with the signal variation larger than a threshold as well as its corresponding direction. In other words, the user not only rotates the knob to control its orientation angle but also tilts the knob to one of the directions as another control option. It works like buttons. The user can click, double click, or press the knob towards one of the directions. In the embodiment as shown in FIG. 14, the user can control to click, double click, or press the knob towards one of the following four directions, east, west, south, and north.

In another embodiment, the touch sensitive processing apparatus 9910 may find two adjacent third ring electrodes with their driving signal variations larger than the threshold. And a middle direction between the two corresponding directions can be determined accordingly. For example, when the signal variations of the two adjacent third ring electrodes 1440-1 and 1440-2 are the largest two values, it means that the user wants to control the knob towards northeast in the middle of north and east. In the embodiment as shown in FIG. 14, except for east, west, north, and south, the user can control to click, double click, or press the knob towards one of the following four directions, southeast, southwest, northwest, and northeast.

Person having ordinary skill in the art can understand that when the N third ring electrodes occupy identical angular ring sections, the touch sensitive processing apparatus 9910 provided by the present application can provide knob button-like control towards N directions or 2N directions, where N is a natural number larger than 1.

However, the N third ring electrodes may not occupy identical angular ring sections. The area size of each the third ring electrodes may not be identical. For example, if the area size of one specified third ring electrode is smaller or the angular section it occupies is smaller, the user has to more precisely control the knob to tilt toward the direction corresponding to the specified third ring electrode. Reversely, if the area size of one specified third ring electrode is larger or the angular section it occupies is larger, the user can easily control the knob to tilt toward the direction corresponding to the specified third ring electrode.

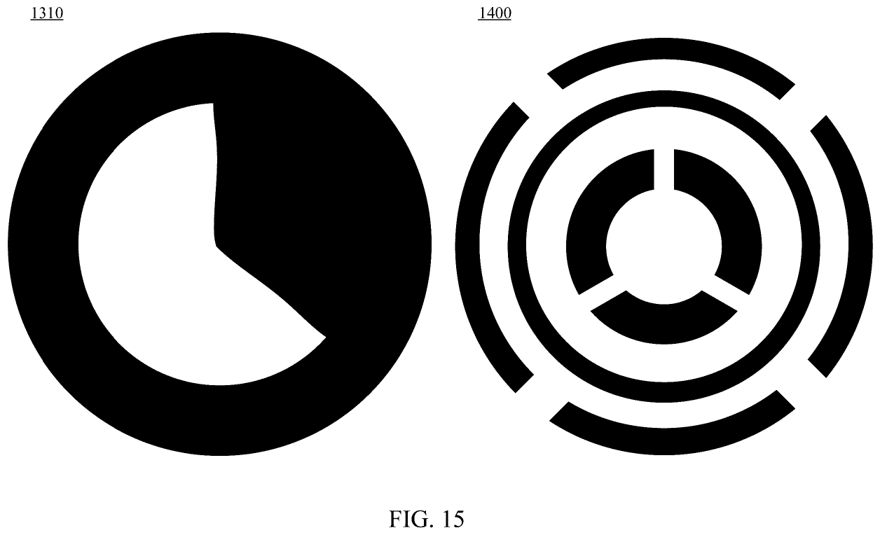

Please refer to FIG. 15, which illustrates a diagram of the knob electrode 1310 and the knob electrode area 1400 in accordance with an embodiment of the present application. As shown in FIG. 15, the knob electrode 1310 covers on top of the corresponding knob electrode area 1400. The knob electrode 1310 and the knob electrode area 1400 are corresponding to a common rotational axis. Wherever the knob points to, the outer ring part of the knob electrode 1310 would cover on top of the multiple third ring electrodes such that the knob electrode 1310 and the multiple third ring electrode form capacitors.

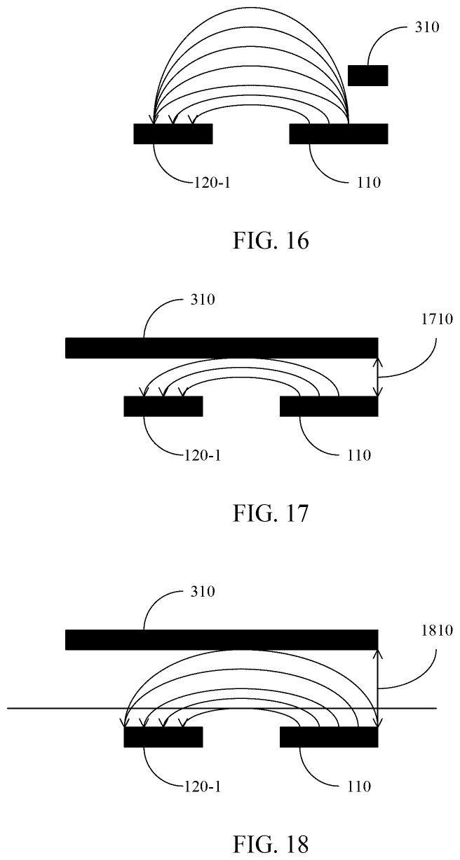

Please refer to FIG. 16, which illustrates a sectional diagram of the knob electrode 310, the driving knob electrode 110, and the sensing knob electrode 120-1 in accordance with an embodiment of the present application. The arrows as shown in FIG. 16 represent multiple electric lines between the driving knob electrode 110 and the sensing knob electrode 120-1. The driving signals emitted from the driving knob electrode 110 can reach the sensing knob electrode 120-1 via these electric lines. When the fan part 320 of the knob electrode 310 does not cover on top of the sensing knob electrode 120-1, only the outer ring part of the knob electrode 310 blocks some electric lines.

Please refer to FIG. 17, which illustrates another sectional diagram of the knob electrode 310, the driving knob electrode 110, and the sensing knob electrode 120-1 of the embodiment as shown in FIG. 16. When the fan part 320 of the knob electrode 310 does cover on top of the sensing knob electrode 120-1, most electric lines are blocked. The driving signals emitted from the driving knob electrode 110 only reach the sensing knob electrode 120-1 via fewer electric lines. Hence, the quantity of driving signals sensed from the sensing knob electrode 120-1 by the touch sensitive processing apparatus 9910 becomes lesser.

As discussed in the descriptions related to FIGS. 16 and 17, person having ordinary skill in the art can understand that when the fan part 320 of the knob electrode 310 covers on top of the sensing knob electrode 120-1, the touch sensitive processing apparatus 9910 can determine that the fan part 320 does cover on top of the sensing knob electrode 120-1 according to the variation of driving signals sensed from the sensing knob electrode 120-1. When the fan part 320 covers on top of two adjacent sensing knob electrodes, the touch sensitive processing apparatus 9910 can determine a ratio of the two adjacent sensing knob electrodes which are covered by the fan part 320 according to the variations of driving signals sensed from the two adjacent sensing knob electrodes. The orientation angle of the knob 300 can be further determined accordingly.

Please refer to FIG. 18, which illustrates another sectional diagram of the knob electrode 310, the driving knob electrode 110, and the sensing knob electrode 120-1 in the embodiment as shown in FIG. 17. Comparing with the embodiment as shown in FIG. 18, the distance 1710 between the knob electrode 310 and the driving knob electrode 110 in the embodiment as shown in FIG. 17 is shorter. The knob electrode 310 blocks more electric lines. The distance 1810 as shown in FIG. 18 is longer than the distance 1710, the knob electrode 310 blocks fewer electric lines.

Person having ordinary skill in the art can understand that there may exists a stretch mechanism included in the knob such that the user can control a distance between the knob electrode 310 and the driving knob electrode 110. Since the length of the distance influences the quantity of the capacitance, the touch sensitive processing apparatus 9910 can determine the distance based on the variation of signals received by the sensing knob electrode 120-1.

In an embodiment, the stretch mechanism provides elasticity in the vertical direction. When the user presses, the distance shrinks accordingly. When the user does not apply the force, the distance grows. In other words, the distance determined by the touch sensitive processing apparatus 9910 can reflect the pressure on the knob in the vertical direction. Alternative speaking, the touch sensitive processing apparatus 9910 can output the pressure value of the knob. The pressure value is between a maximum and a maximum.

In an alternative embodiment, the stretch mechanism may have multiple levels. For example, the pressure on the knob may be corresponding to one of two levels. When the knob is set at the largest pressure level, the touch sensitive processing apparatus 9910 can determine that the knob is pressed by the user. When the knob is set at the lowest pressure level, the touch sensitive processing apparatus 9910 can determine that the knob is bounced back. When the pressure is determined in between its maximum and minimum, the touch sensitive processing apparatus 9910 can output one of the maximum and the minimum depending on which one the pressure value is closer to. Or the touch sensitive processing apparatus 9910 can output one of the knob states, pressed or bounced back. Person having ordinary skill in the art can understand that the pressure on the knob may be classified into N levels, where N is a positive integer larger than 1.

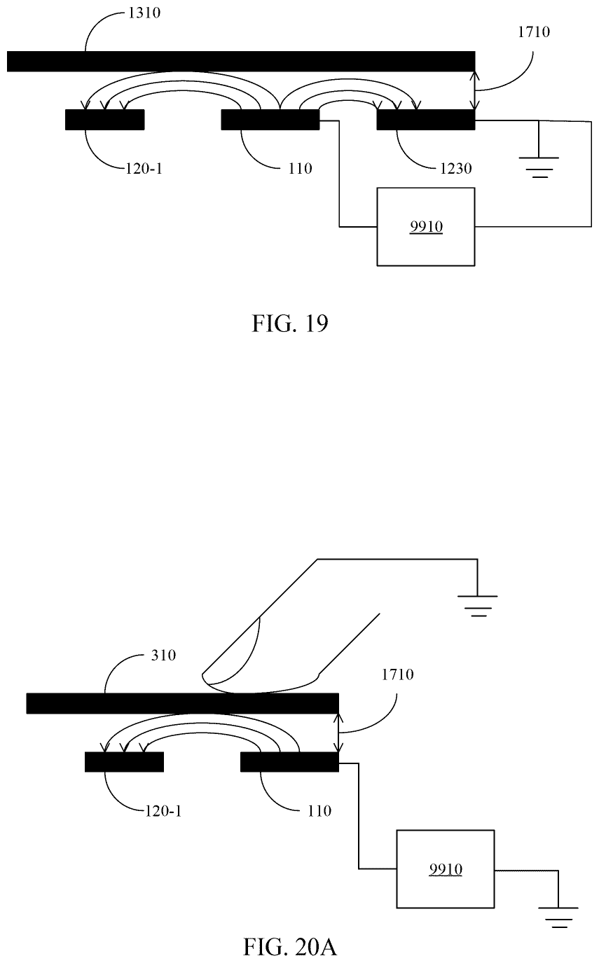

Please refer to FIG. 19, which illustrates a sectional diagram of the knob electrode 1310, the driving knob electrode 110, the sensing knob electrode 120-1, and the third ring electrode 1230 in the embodiment as shown in FIG. 14. Comparing with the embodiment as shown in FIG. 17, capacitors are formed between the knob electrode 1310 and the driving knob electrode 110, the sensing knob electrode 120-1, and the third ring electrode 1230, respectively. Similar to the embodiment as shown in FIG. 12, the third ring electrode 1230 is connected to the ground potential, and so is the touch sensitive processing apparatus 9910.

After being emitted from the driving knob electrode 110, part of the driving signals would be returned to the touch sensitive processing apparatus 9910 via the knob electrode 1310 and the third ring electrode 1230 sequentially. Hence, the driving signals sensed by the touch sensitive processing apparatus 9910 via the knob electrode 1310 and the sensing knob electrode 120-1 would be reduced. As a result, person having ordinary skill in the art can understand that if the knob electrode area 1200 comprise the third ring electrode 1230, the driving signals sensed by the touch sensitive processing apparatus 9910 via the sensing knob electrode 120-1 would be lesser than the driving signals sensed in the embodiment as shown in FIG. 17. Consequently, the touch sensitive processing apparatus 9910 can determine that the knob electrode 1310 covers on top of the sensing knob electrode 120-1 more clearly.

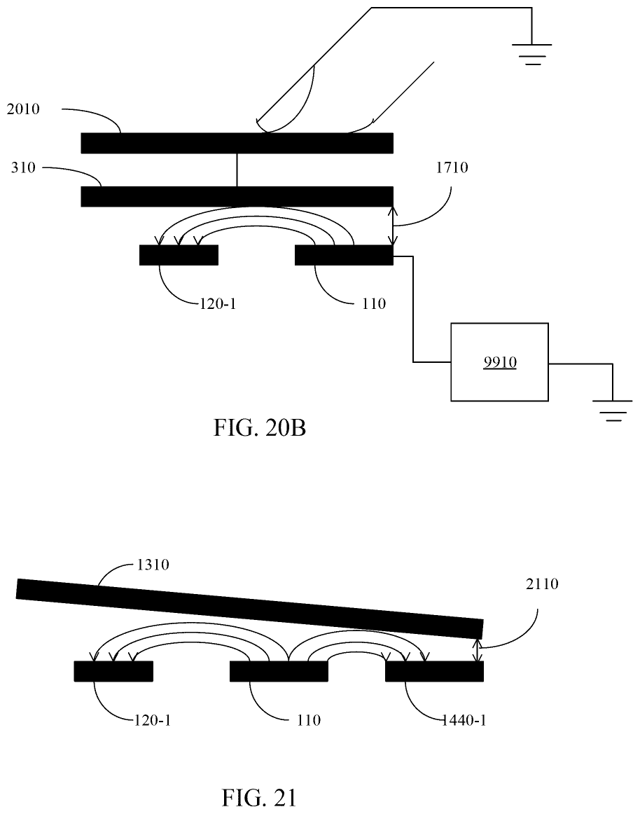

Please refer to FIG. 20A, which illustrates a sectional diagram of the knob electrode 310, the driving knob electrode 110, and the sensing knob electrode 120-1 in the embodiment as shown in FIG. 3. As shown in FIG. 20A, the finger can directly touch the knob electrode 310. Or alternatively, the distance between the finger and the knob electrode 310 can be reduced to a thin layer of a paint, a plastic foam, or a sticker. The finger is connected to the ground potential via human body. And the touch sensitive processing apparatus 9910 can be connected to the ground potential via the human body or other objects (e.g., a table).

After being emitted from the driving knob electrode 110, part of the driving signals would be returned to the touch sensitive processing apparatus 9910 via the knob electrode 310, the finger, and the human body. Hence, the driving signals sensed by the touch sensitive processing apparatus 9910 via the knob electrode 1310 and the sensing knob electrode 120-1 would be reduced. As a result, person having ordinary skill in the art can understand that in case the finger directly touches the knob electrode 310 or the distance between the finger and the knob electrode 310 is very small, the driving signals sensed by the touch sensitive processing apparatus 9910 via the sensing knob electrode 120-1 would be lesser than the driving signals sensed in the embodiment as shown in FIG. 17. Consequently, the touch sensitive processing apparatus 9910 can determine that the knob electrode 310 covers on top of the sensing knob electrode 120-1 more clearly.

Please refer to FIG. 20B, which illustrates a variant of the embodiment as shown in FIG. 20A. The knob as shown in FIG. 20B further comprises a second knob electrode 2010. The second knob electrode 2010 can be electrically coupled to the knob electrode 310 via a conductor and a conductive wire. the finger can directly touch the second knob electrode 2010. Or alternatively, the distance between the finger and the knob electrode 2010 can be reduced to a thin layer of a paint, a plastic foam, or a sticker. The finger is connected to the ground potential via human body. And the touch sensitive processing apparatus 9910 can be connected to the ground potential via the human body or other objects (e.g., a table).

After being emitted from the driving knob electrode 110, part of the driving signals would be returned to the touch sensitive processing apparatus 9910 via the knob electrode 310, the second knob electrode 2010, the finger, and the human body. Hence, the driving signals sensed by the touch sensitive processing apparatus 9910 via the knob electrode 310, and the sensing knob electrode 120-1 would be reduced. As a result, person having ordinary skill in the art can understand that in case the finger directly touches the second knob electrode 2010 or the distance between the finger and the knob electrode 2010 is very small, the driving signals sensed by the touch sensitive processing apparatus 9910 via the sensing knob electrode 120-1 would be lesser than the driving signals sensed in the embodiment as shown in FIG. 17. Consequently, the touch sensitive processing apparatus 9910 can determine that the knob electrode 310 covers on top of the sensing knob electrode 120-1 more clearly.

Please refer to FIG. 21, which illustrates a sectional diagram of the knob electrode 1310, the driving knob electrode 110, the sensing knob electrode 120-1, and the third ring electrode 1440-1 in the embodiment as shown in FIG. 15. Capacitors are formed between the knob electrode 1310 and the driving knob electrode 110, the sensing knob electrode 120-1, and the third ring electrode 1440-1, respectively. As shown in FIG. 21, the knob electrode 1310 tilts toward the direction of the third ring electrode 1440-1. Person having ordinary skill in the art can understand that the knob may include a mechanical design which allows a plane corresponding to the knob electrode 130 can be tilted toward a direction. For example, the mechanical design may place a flexible mechanism in the circular center of the knob for connecting the knob electrode 1310.

Comparing with the embodiment as shown in FIG. 17, the distance 2110 between the knob electrode 1310 and the third ring electrode 1440-1 is smaller than the distance 1710 as shown in FIG. 17. When the knob electrode 1310 is tilted, the distance between the knob electrode 1310 and the third ring electrode 1440-1 decreases. Hence, the capacitance between the knob electrode 1310 and the third ring electrode 1440-1 grows. Reversely, in case that the distance between the knob electrode 1310 and the third ring electrode 1440-1 increases, the capacitance between the knob electrode 1310 and the third ring electrode 1440-1 shrinks.

After being emitted from the driving knob electrode 110, part of the driving signals would be returned to the touch sensitive processing apparatus 9910 via the knob electrode 1310 and the third ring electrode 1440-1. Hence, the driving signals sensed by the touch sensitive processing apparatus 9910 via the knob electrode 1310, and the sensing knob electrode 120-1 would be reduced. As a result, person having ordinary skill in the art can understand that the touch sensitive processing apparatus 9910 can determine that the knob electrode 310 covers on top of the sensing knob electrode 120-1 more clearly.

In abovementioned embodiments, the driving knob electrode 110 and the multiple sensing knob electrodes included in the knob electrode area form two circles. If these two circles are stretched to straight lines, a slider electrode area can be formed. Person having ordinary skill in the art can understand that the touch sensitive processing apparatus 9910 as shown in FIG. 1 can connect to the slider electrode area via the interconnection network module. What the user controls becomes moving the slider in a straight line from rotating the knob.

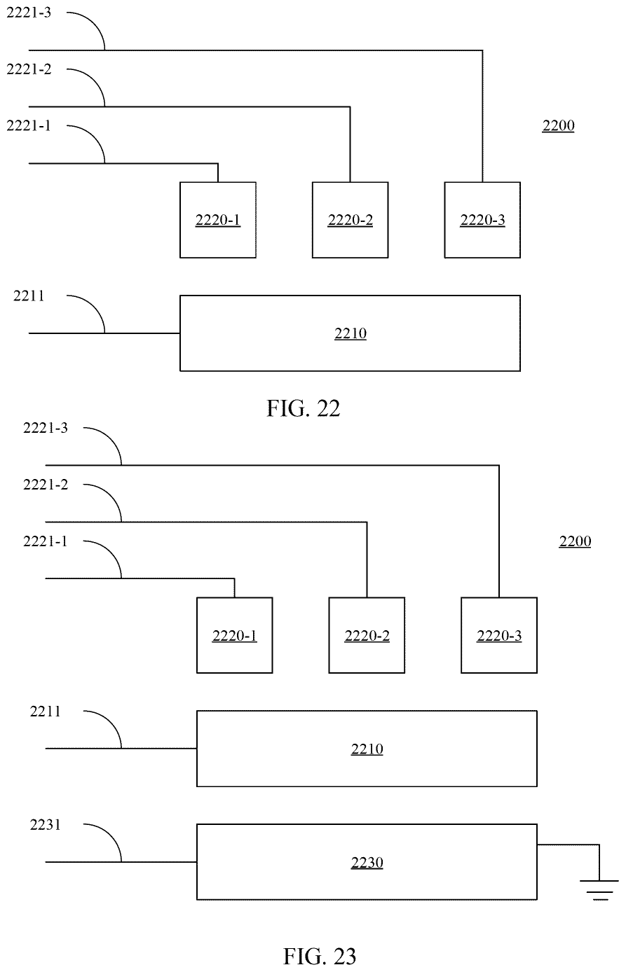

Please refer to FIG. 22, which depicts a top view of a slider electrode area 2200 according to an embodiment of the present application. In the slider electrode area 2200, an elongated driving slider electrode 2210 and N sensing slider electrodes corresponding to the driving slider electrode 2210 presents, where N is a positive integer larger than 1. The driving slider electrode 2210 is longer along the first direction (e.g., the horizontal axis). The N sensing slider electrodes are evenly arranged along the first direction. The driving slider electrode 2210 connects to the interconnection network module 9911 of the touch sensitive processing apparatus 9910 via a conductive wire 2211. The three sensing slider electrodes 2220-1~2220-3 connect to the interconnection network module 9911 of the touch sensitive processing apparatus 9911 via the conductive wires 2221-1~2222-3, respectively.

Although in the embodiment as shown in FIG. 22, the left edge of the most left sensing slider electrode 2220-1 is aligned with the left edge of the driving slider electrode 2210 and the right edge of the most right sensing slider electrode 2220-3 is also aligned with the right edge of the driving slider electrode 2210, person having ordinary skill in the art can understand that no alignments are required in other embodiments.

In order to calculate conveniently, the area size and shape of each the N sensing slider electrodes may be identical. The distances between each the N sensing slider electrodes and the driving slider electrode 2210 may be also identical.

Please refer to FIG. 23, which depicts a variant of the slider electrode area 2200 of the embodiment as shown in FIG. 22. If no particular description, the description of the embodiment as shown in FIG. 22 can be applied to the variant as shown in FIG. 23. Comparing with FIG. 22, the slider electrode area 2200 as shown in FIG. 23 further comprises a third electrode 2230 which connects to the ground potential and the DC voltage potential. Person having ordinary skill in the art can understand the functions of the third electrode 2230 are similar to the functions of the third ring electrode 1230 as shown in FIG. 12. The shape of the third electrode 2230 is also a stretched straight version of the third ring electrode 1230.

In one embodiment, the third electrode 2230 and the N sensing slider electrodes are arranged in the opposite sides of the driving slider electrode 2210. In one embodiment, the length of the third electrode 2230 along the first direction (e.g., the horizontal axis) equals to the length of the length of the driving slider electrode 2210. In one embodiment, the length of the third electrode 2230 along the second direction (e.g., the vertical axis) equals to the length of the length of the driving slider electrode 2210. Person having ordinary skill in the art can understand that the shape of the third electrode 2230 is not limited in the present application.

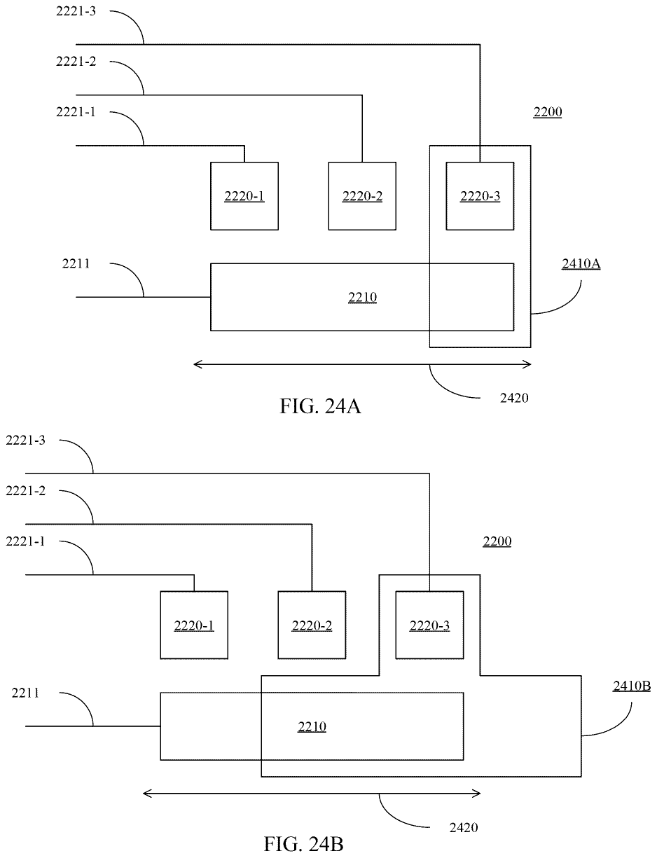

Please refer to FIG. 24A, which illustrates a top view of the slider electrode area 2200 as shown in FIG. 22 which is covered by a slider electrode 2410A. The slider electrode 2410A may be a part of a slider. The slider electrode 2410A may be directly in contact with a finger. Or alternatively, there is dielectric material between the slider and the finger. The slider electrode 2410A may be moveable along the first direction 2420 (e.g., the horizontal axis).

The slider electrode 2410A is not in contact with the driving slider electrode 2210 and the N sensing slider electrodes. The slider electrode 2410A may cover one or two adjacent sensing slider electrodes. The touch sensitive processing apparatus 9910 can transmit driving signals via the driving slider electrode 2210. After the driving signals are induced by the slider electrode 2410A, the one or two adjacent sensing slider electrodes under the slider electrode 2410A would induce the driving signals consequently. The touch sensitive processing apparatus 9910 can sense the driving signals via the one or two adjacent sensing slider electrodes. According to the signal variations sensed from each the sensing slider electrodes, the touch sensitive processing apparatus 9910 is able to calculate a position of the slider electrode 2410A.

Please refer to FIG. 24B, which illustrates a top view of the slider electrode area 2200 as shown in FIG. 22 which is covered by another slider electrode 2410B. In order to enhance the capacitor between the slider electrode 2410B and the driving slider electrode 2210, an upper part of the shape of the slider electrode 2410B is enlarged for covering on top of the driving slider electrode 2210. Comparing with the embodiment as shown in FIG. 24A, the driving signals sensed from the sensing slider electrode 2220-3 as shown in FIG. 24B has greater intensity. As a result, the touch sensitive processing apparatus 9910 can calculate the position of the slider electrode 2410B more precisely.

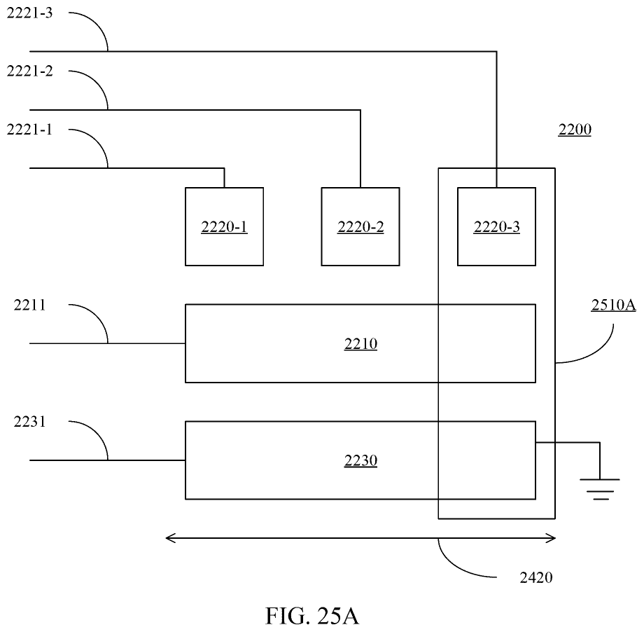

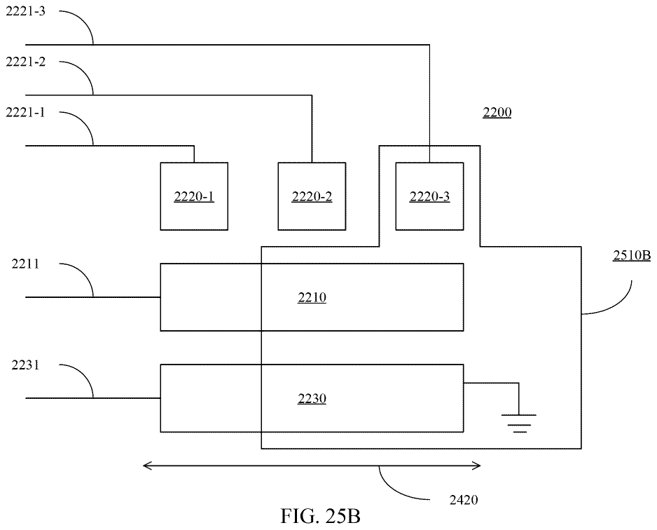

Please refer to FIG. 25A, which illustrates a top view of the slider electrode area 2200 as shown in FIG. 23 which is covered by a slider electrode 2510A. The embodiment as shown in FIG. 25A is also a variant of the embodiment as shown in FIG. 24A. Because the slider electrode 2510A covers on top of the third electrode 2230, part of the driving signals would be diverted to the ground potential via the third electrode 2230.

Please refer to FIG. 25B, which illustrates a top view of the slider electrode area 2200 as shown in FIG. 23 which is covered by another slider electrode 2510B. The embodiment as shown in FIG. 25B is also a variant of the embodiment as shown in FIG. 24B. In order to enhance the capacitance between the slider electrode 2510B and the driving slider electrode 2210, an upper part of the shape of the slider electrode 2510B is enlarged for covering on top of the driving slider electrode 2210. In order to enhance the capacitance between the slider electrode 2510B and the third electrode 2230, the shape of the slider electrode 2510B is enlarged for covering on top of the third electrode 2230. Comparing with the embodiment as shown in FIG. 25A, more driving signals are diverted to the ground potential via the third electrode 2230 because more area of the third electrode 2230 is covered by the slider electrode 2510B.

In the embodiments as shown in FIG. 22~25B, the position of slider can be calculated based on a ratio between the two largest sensed signals of the N sensing slider electrodes. For example, in case the slider 2200 is positioned on top of the sensing slider electrode 2220-3, the sensed signal from the sensing slider electrode 2220-3 is at its maximum, the sensed signals from the sensing slider electrodes 2220-1 and 2220-2 should be less than a threshold value, respectively. Therefore, the processor module 9914 of the touch sensitive processing apparatus 9910 can determine that the position of the slider 2200 is on top of the sensing slider electrode 2220-3.

In case the position of the slider 220 is on top of two adjacent sensing slider electrodes, a ratio of the sensed signal strengths corresponding to the two adjacent sensing slider electrodes can be used to calculate the position of the slider 2200 with respect to the two adjacent sensing slider electrodes. The ratio of the two adjacent sensed signals can be corresponding to a ratio of area sizes of the two adjacent slider electrodes which are covered by the slider electrode. Hence, the calculation result of the ratio of the two adjacent sensed signals can be used to determine the ratio of area sizes of the two adjacent slider electrodes which are covered by the slider electrode. In other words, a relative position of the slider electrode with respect to the two adjacent slider electrodes. i.e., the position of the slider 2200, can be determined.

Person having ordinary skill in the art can understand that although the embodiments provided by the present application can use the touch sensitive processing apparatus 9910, the present application does not require that the touch sensitive processing apparatus 9910 must connect to the touch screen 9920. In some embodiments, the touch sensitive processing apparatus 9910 can only connect to the knob electrode area or the slider electrode area. It is not required to connect to the touch screen 9920. In these embodiments, the touch sensitive processing apparatus 9910 does not need to include the interconnection network module 9911. The driving circuit module 9912 may be directly connected to the driving knob electrode or the driving slider electrode. The sensing circuit module 9913 may be directly connected to the sensing knob electrodes or the sensing slider electrodes. The third ring electrode or the third electrode may be directly connected to the ground potential or the DC voltage. Because it does not need the interconnection network module 9911 to connect dozens or even hundreds of touch electrodes of the touch screen 9922 in a time-sharing manner, large die size and control circuits can be eliminated.

Besides, in case that the touch sensitive processing apparatus 9910 only connects to the knob electrode area or the slider electrode area, it may not need the complicated processor module 9914. In some embodiments, it may use FPGA and/or ASIC to implement the knob detecting method or the slider detecting method provided by the present application. Consequently, the microprocessor, the system memory, and read-only memory for storing firmware required by the processor module 9914 can be omitted. More costs can be saved accordingly.

However, person having ordinary skill in the art can understand that, in case that the touch sensitive processing apparatus 9910 is required to connect to the touch screen 9920, the processor module 9914 and the interconnection network module 9911 are mandatory. In addition to the mandatory costs, the touch sensitive processing apparatus 9910 may be further configured to connect the knob electrode area or the slider electrode area. Because the hardware cost is already almost paid, the knob or slider detecting method can be added to the touch sensitive processing apparatus 9910 by increasing a small cost of increased firmware size and system memory space.

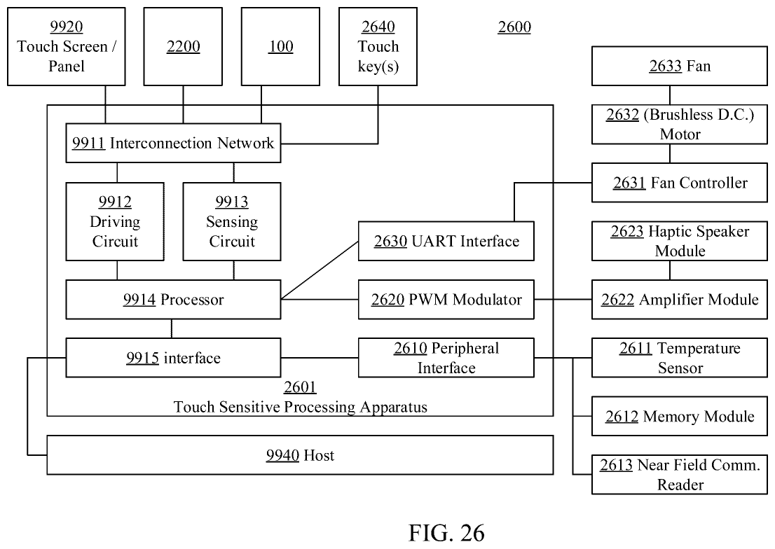

Please refer to FIG. 26, which illustrates a block diagram of a touch system 2600 in accordance with an embodiment of the present application. The touch system 2600 may be a variant of the touch system 9900 as shown in FIG. 1. The touch sensitive processing apparatus 2601 is also a variant of the touch sensitive processing apparatus 9910. The touch sensitive processing apparatus 2601 similarly comprises the interconnection network module 9910, the driving circuit module 9912, the sensing circuit module 9913, the processor module 9914, and the interface module 9915. The interconnection network module 9910 of the touch sensitive processing apparatus 2601 may connect to the touch screen 9920, the knob electrode area 100, the slider electrode area 2200, and one or more touch buttons 2640.

The touch button 2640 may be a capacitive sensing touch button, comprises a first button electrode and a second button electrode both connected to the interconnection network module 9910. The touch sensitive processing apparatus 2601 can emit driving signals via the first button electrode and sense the driving signals induced by the second button electrode. Thus, it can determine whether the user approaches or touches the touch button 2640 according to the driving signal variation.

The touch sensitive processing apparatus 2601 may comprises a peripheral device connection interface 2610, e.g., common industrial standard interfaces such as I²C and USB. The peripheral device connection interface 2610 may comprise a master module which is responsible for connecting other external modules. As shown in FIG. 26, the peripheral device connection interface 2610 may comprise one or more modules. For example, one or more temperature sensors 2611, external memory modules 2612 (e.g., flash memory or EEPROM), or near-field communication reader 2613 etc. Person having ordinary skill in the art can understand that the number and the types of the external modules are only limited to the constraints set by the specifications of the industrial standard interfaces.

The host 9940 can execute driver programs corresponding to the external modules to connect the external modules via the interface module 9915 and the peripheral device connection interface 2610 of the touch sensitive processing apparatus 2601. Because the touch sensitive processing apparatus 2601 is only responsible for delivering messages between the external modules and the host 9940, the touch sensitive processing apparatus 2601 is transparent to the driver programs executed by the host 9940. The host 9940 can directly control and communicate with the external modules.

As a result, the touch sensitive processing apparatus 2601 can be additionally used as a hub of various kinds of peripheral devices. Consequently, the host 9940 can connect to more external modules via the touch sensitive processing apparatus 2601 for obtaining more functions. And it does not need to expand the ports provided by the I/O interface module 9941. With this kind of flexibility, the volume of the touch system 2600 can be reduced further.

The touch sensitive processing apparatus 2601 may comprise a PWM modulator 2620 for outputting PWM signals to an external amplifier module 2622. The amplifier module 2622 is configured to push a haptic speaker module 2623, which is usually installed behind the touch screen 9920 or touch panel. When the touch screen 9920 is touched by the user, the haptic speaker module 2623 responds to emit sounds so as the touch screen 9920 is haptically vibrated. As a result, the user would feel haptic feedback from the finger. Person having ordinary skill in the art can understand that the haptic speaker module 2623 may be installed near the knob electrode area 100, the slider electrode area 2200, or one or more touch buttons 2640 for providing haptic feedback signals to the user.

Since the processor module 9914 is aware of the touch situations of the touch screen 9920, the knob electrode area 100, the slider electrode area 2200, or one or more touch buttons 2640, the processor module 9914 may directly issue digital command to have the PWM modulator 2620 emit the modulated signals so as the amplifier module 2622 and the haptic speaker module 2623 react to provide haptic feedback.

The touch sensitive processing apparatus 2601 may comprise one or more Universal Asynchronous Receiver and Transmitter (UART) interfaces 2630 to control or communicate with external modules. In the embodiment as shown in FIG. 26, the UART interface 2630 may be configured to connect one or more fan controller 2631. The fan controller 2631 may be configured to drive fans through an electric motor 2632 for cooling. The electric motor 2632 may be a brushless DC motor or other kind of electric motors.

Person having ordinary skill in the art can understand that the UART interface 2630 may be replaced with General Purpose Input/Output (GPIO) interface. The PWM modulator 2620, the UART interface 2630, or the GPIO interface enable the processor module 9914 conveniently issue digital commands to control the external modules.

In the embodiments as shown in FIG. 3, FIG. 24A, and FIG. 24B, in case the weather is extremely cold, there exists a great chance of freezing ice makes it difficult to rotate the knob or to move the slider. Under this kind of circumstances, in some embodiments provided by the present application, the mechanic structure coupling the knob or the slider can be decoupled from the knob electrode area or the slider electrode area, respectively. When the touch sensitive processing apparatus 9900 is aware of the decoupling of the knob or the slider, it may enter a finger driving mode. In this case, the finger may be used to replace the role of the knob electrode or the slider electrode.

When the finger approaches or touches the space between the driving knob electrode 110 and the sensing knob electrode 120-1, or the finger approaches or touches the sensing knob electrode 120-1, the touch sensitive processing apparatus 9900 can determine that the user wants to press the sensing knob electrode 120-1 according to the sensed value of the sensing knob electrode 120-1 which is different from the sensed values of the sensing knob electrodes 120-2 and 120-3 or according to the sensed value of the sensing knob electrode 120-1 which is different from the basis value.

When the finger approaches or touches the space between the driving knob electrode 110, the sensing knob electrode 120-1, and the sensing knob electrode 120-2, or the finger approaches or touches somewhere in between the sensing knob electrode 120-1 and the sensing knob electrode 120-2, the touch sensitive processing apparatus 9900 can determine that the user wants to press the sensing knob electrode 120-1 and the sensing knob electrode 120-2 simultaneously according to the sensed values of the sensing knob electrode 120-1 and the sensing knob electrode 120-2 which are different from the basis value, respectively.

Similarly, when the finger approaches or touches the space between the slider electrode 2210 and the sensing slider electrode 2220-1, or the finger approaches or touches the sensing slider electrode 2220-1, the touch sensitive processing apparatus 9900 can determine that the user wants to press the sensing slider electrode 2220-1 according to the sensed value of the sensing slider electrode 2220-1 which is different from the sensed values of the sensing slider electrodes 2220-2 and 2220-3, or according to the sensed value of the sensing slider electrode 120-1 which is different from the basis value.

Similarly, when the finger approaches or touches the space between the driving slider electrode 2210, the sensing slider electrode 2220-1, and the sensing slider electrode 2220-2, or the finger approaches or touches somewhere in between the sensing slider electrode 2220-1 and the sensing slider electrode 2220-2. The touch sensitive processing apparatus 9900 can determine that the user wants to press the sensing slider electrode 2220-1 and the sensing slider electrode 2220-2 simultaneously according to the sensed values of the sensing slider electrode 2220-1 and the sensing slider electrode 2220-2 which are different from the basis values, respectively.

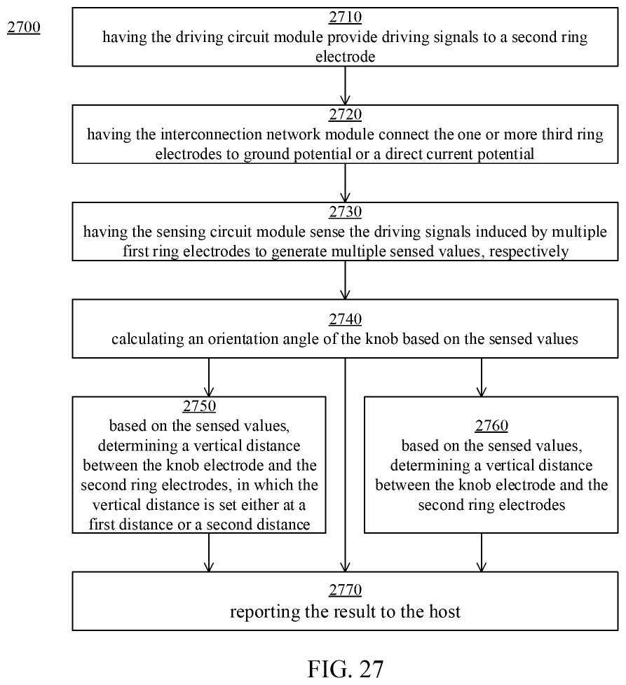

Please refer to FIG. 27, which is a touch sensitive processing method 2700 applicable to capacitive sensing knob device in accordance with an embodiment of the present application. The touch sensitive processing method 2700 is applicable to the touch system 9900 as shown in FIG. 1, especially to the touch sensitive processing apparatus 9910. The processor module 9914 is able to realize the touch sensitive processing method 2700 based on multiple instructions and data stored in a non-volatile memory. When two steps have no direct or indirect causal relationship, the present application does not limit the execution sequence of these two steps. The touch sensitive processing method 2700 may begin at step 2710.

Step 2710: having the driving circuit module provide driving signals to a second ring electrode. The second ring electrode may include a driving knob electrode.

Optional step 2720: having the interconnection network module connect the one or more third ring electrodes to ground potential or a direct current voltage/potential.

Step 2730: having the sensing circuit module sense the driving signals induced by multiple first ring electrodes to generate multiple sensed values, respectively. The multiple first ring electrodes may include sensing knob electrodes.

Step 2740: calculating an orientation angle of the knob based on the sensed values. According to the sensed values, the calculating step may further includes finding two largest adjacent sensed values among the sensed values; calculating a ratio between the largest two adjacent sensed values; and calculating the orientation angle of the knob based on the ratio. Next, the flow may proceed to optional step 2750, optional step 2760, or step 2770.

Optional step 2750: based on the sensed values, determining a vertical distance between the knob electrode and the second ring electrode, in which the vertical distance is set either at a first distance or a second distance; when the vertical distance is set at the first distance, determining that the knob is in a state of being pressed down; and when the vertical distance is set at the second distance, determining that the knob is in another state of being unpressed.

Optional step 2760: based on the sensed values, determining a vertical distance between the knob electrode and the second ring electrode; and based on the vertical distance, calculating a value of pressure on the knob.

Step 2770: reporting the result to the host.

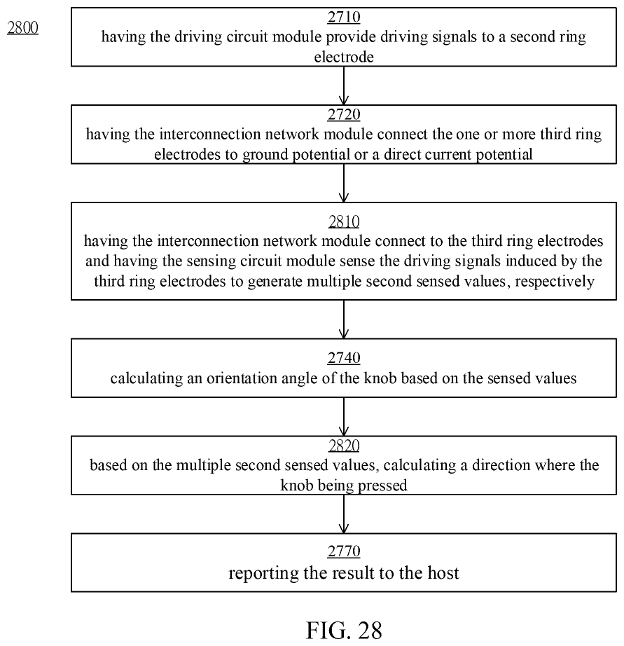

Please refer to FIG. 28, which depicts a flowchart diagram of a touch sensitive processing apparatus 2800 applicable to capacitive sensing knob apparatus in accordance with an embodiment of the present application. The touch sensitive processing apparatus 2800 is applicable to the touch system 9900 as shown in FIG. 1, especially to the touch sensitive processing apparatus 9910. The processor module 9914 is able to realize the touch sensitive processing method 2800 based on multiple instructions and data stored in a non-volatile memory. When two steps have no direct or indirect causal relationship, the present application does not limit the execution sequence of these two steps. The touch sensitive processing method 2800 is a variant of the touch sensitive processing method 2700. The touch sensitive processing method 2800 is especially adapted to the embodiment as shown in FIG. 21. Some steps of the touch sensitive processing method 2700 are reused by the touch sensitive processing method 2800. No duplicated elaboration is provided here. The touch sensitive processing method 2800 may begin at step 2710.

Step 2810: having the interconnection network module connect to the third ring electrodes and having the sensing circuit module sense the driving signals induced by the third ring electrodes to generate multiple second sensed values, respectively.

Step 2820: based on the multiple second sensed values, calculating a direction where the knob being pressed.

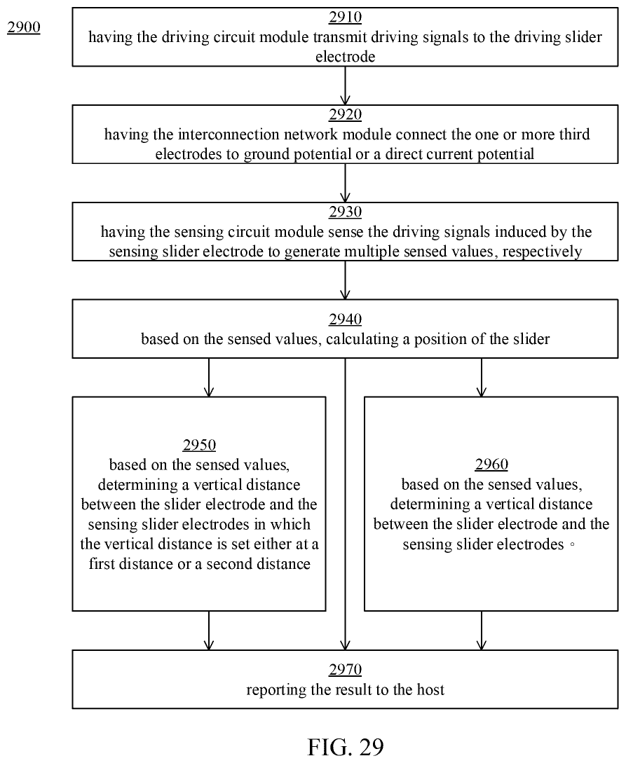

Please refer to FIG. 29, which depicts a flowchart diagram of a touch sensitive processing apparatus 2900 applicable to capacitive sensing slider apparatus in accordance with an embodiment of the present application. The touch sensitive processing apparatus 2900 is applicable to the touch system 9900 as shown in FIG. 1, especially to the touch sensitive processing apparatus 9910. The processor module 9914 is able to realize the touch sensitive processing method 2900 based on multiple instructions and data stored in a non-volatile memory. When two steps have no direct or indirect causal relationship, the present application does not limit the execution sequence of these two steps. The touch sensitive processing method 2900 may begin at step 2910.

Step 2910: having the driving circuit module transmit driving signals to the driving slider electrode.

Optional step 2920: having the interconnection network module connect the one or more third electrodes to ground potential or a direct current potential.

Step 2930: having the sensing circuit module sense the driving signals induced by the sensing slider electrode to generate multiple sensed values, respectively.

Step 2940: based on the sensed values, calculating a position of the slider. The calculating step further includes finding two largest adjacent sensed values among the sensed values; calculating a ratio between the largest two adjacent sensed values; and calculating the position of the slider based on the ratio. Next, the flow may proceed to optional step 2950, optional step 2960, or step 2970.

Optional step 2950: based on the sensed values, determining a vertical distance between the slider electrode and the sensing slider electrodes in which the vertical distance is set either at a first distance or a second distance; when the vertical distance is set at the first distance, determining that the slider is in a state of being pressed down; and when the vertical distance is set at the second distance, determining that the slider is in another state of being unpressed.

Optional step 2960: based on the sensed values, determining a vertical distance between the slider electrode and the sensing slider electrodes; and calculating a value of pressure on the slider based on the vertical distance.

Step 2970: reporting the result to the host.

According to an embodiment of the present application, a capacitive sensing knob apparatus is provided. The capacitive sensing knob apparatus, comprising: a knob electrode area, which comprises: multiple first ring electrodes, which are disposed at a circumference of a first circle evenly, area sizes of each the first ring electrodes are identical, shapes of each the first ring electrodes are similar and pointing to a center of the first circle; and a second ring electrode, which is disposed at a circumference of a second circle, wherein the first circle and the second circle are concentric circles; and a knob which is rotatable around the center, wherein the knob comprises a first knob electrode, when the knob is oriented to a first angle, the first knob electrode simultaneously covers parts of the two adjacent first ring electrodes and a part of the second ring electrode.

Preferably, in order to let the user more conveniently indicates the orientation angle of the knob, wherein the knob electrode area comprises N first ring electrodes, where N is a positive integer equals to or larger than 3, wherein when the knob is oriented to the first angle, the first knob electrode simultaneously covers parts of the (N-1) adjacent first ring electrodes and a part of the second ring electrode, one of the first ring electrodes is uncovered. The situation is alike the embodiment as shown in FIG. 8.

Preferably, in order to let the user more conveniently indicates the orientation angle of the knob, wherein when the knob is oriented to a second angle, the first knob electrode simultaneously covers one of the first ring electrodes and a part of the second ring electrode. The situation is alike the embodiment as shown in FIG. 4.

Preferably, in order to let the touch sensitive processing apparatus more easily to detect the orientation angle of the knob, wherein the knob electrode area further comprises one or more third ring electrodes, which are disposed at a circumference of a third circle, wherein the first, the second, and the third circles are concentric circles, a diameter of the third circle is larger than a diameter of the second circle, the diameter of the second circle is larger than a diameter of the first circle. The example is alike the embodiment as shown in FIG. 12.

Preferably, in order to let the user uses the knob as directional buttons, wherein the third ring electrodes included in the knob electrode area are disposed at the circumference of the third circle evenly, area sizes of each the third ring electrodes are identical, shapes of each the third ring electrodes are similar and pointing to a center of the third circle. The example is alike the embodiment as shown in FIG. 14. Preferably, in order to let the user use the knob as directional buttons, wherein when the first knob electrode is pressed, at least one distance between the first knob electrode and one of the third ring electrodes is reduced accordingly. The example is alike the embodiment as shown in FIG. 21.

Preferably, in order to let the user more conveniently indicates the orientation angle of the knob, wherein a diameter of the first circle is larger than a diameter of the second circle. The example is alike the embodiment as shown in FIG. 10. Preferably, in order to let the driving signals transmitted from the circular center, wherein a shape of the second ring electrode is a round pie containing a center of the second circle. The example is alike the embodiment as shown in FIG. 10. Preferably, in order to let the touch sensitive processing apparatus more easily to detect the orientation angle of the knob, wherein an area size of the second ring electrode covered by the first knob electrode is identical no matter any orientation angle pointed by the knob. The example is alike the embodiment as shown in FIG. 11.

Preferably, in order to let the user make the knob as a button, wherein the capacitive sensing knob apparatus further comprises a connecting mechanism which is configured to selectively set a vertical distance between the first knob electrode and the second ring electrode at either a first distance or a second distance, wherein the first distance is shorter than the second distance. The example is alike the embodiment as shown in FIGS. 17 and 18.

Preferably, in order to let the user make the knob as a force sensor, wherein the capacitive sensing knob apparatus further comprises a connecting mechanism which is configured to selectively set a vertical distance between the first knob electrode and the second ring electrode between a first distance and a second distance, wherein the first distance is shorter than the second distance, wherein when the knob is not pressed by the user, the connecting mechanism set the vertical distance to the second distance. The example is alike the embodiment as shown in FIGS. 17 and 18.

Preferably, in order to prevent the knob being frozen under low temperature conditions, wherein the capacitive sensing knob apparatus further comprises a connecting mechanism which is configured to selectively couple or to decouple the knob and the knob electrode area.

Preferably, in order to save manufacture cost, wherein the first ring electrodes of the knob electrode area are collocated in a same layer with multiple first electrodes of a touch panel in parallel to a first axis, the second ring electrode of the knob electrode area are collocated in a same layer with multiple second electrodes of the touch panel in parallel to a second axis.

Preferably, in order to reduce the thickness, wherein the multiple first ring electrodes and the second ring electrode are collocated in a same layer.

Preferably, in order to let the touch sensitive processing apparatus more easily to detect and increase signal-to-noise ratio, wherein the knob further comprises a second knob electrode which is in parallel with the first knob electrode, wherein the second knob electrode is electrically coupled to the first knob electrode, the first knob electrode is closer to the knob electrode area than the second knob electrode. The example is alike to the embodiment as shown in FIG. 20B.

According to an embodiment of the present application, a capacitive sensing slider apparatus is provided. The capacitive sensing slider apparatus, comprising: a slider electrode area, comprises multiple sensing slider electrodes in parallel to an axis, area sizes of each the sensing slider electrodes are identical, distances between any two adjacent sensing slider electrodes are identical; a driving slider electrode in parallel to the multiple sensing slider electrodes; and a slider above the slider electrode area, positions of slider being selectively set are in parallel to the axis, the slider comprises a slider electrode, when the slider electrode is at a first position, the slider electrode simultaneously covers parts of two adjacent sensing slider electrodes and a part of the driving slider electrode.

Preferably, in order to let the user more easily set up the position of the slider, wherein when the slider is at a second position, the slider electrode simultaneously covers a part of a single one of the sensing slider electrodes and a part of the driving slider electrode. This example is alike the embodiment as shown in FIG. 24A.

Preferably, in order to let the user more easily set up the position of the slider, wherein area sizes of the one or more sensing slider electrodes covered by the slider electrode are less than an area size of the driving slider electrode covered by the slider electrode. This example is alike the embodiment as shown in FIG. 24B.

Preferably, in order to let the touch sensitive processing apparatus more easily detect the position of the slider, wherein the slider electrode area further comprises one or more third electrodes in parallel to the driving slider electrode, wherein the one or more third electrodes and the sensing slider electrodes are in the opposite sides of the driving slider electrode. The examples are alike the embodiments as shown in FIGS. 25A and 25B.

Preferably, in order to let the user more easily set up the position of the slider, wherein an area size of the one or more sensing slider electrodes covered by the slider electrode is less than an area size of the one or more third electrodes covered by the slider electrode.

Preferably, in order to let the user uses the slider as a button, wherein the capacitive sensing slider apparatus further comprises a connection mechanism, which is configured to selectively set a vertical distance between the slider electrode and the sensing slider electrodes either a first distance or a second distance, wherein the first distance is shorter than the second distance.

Preferably, in order to let the user uses the slider as a force sensor, wherein the capacitive sensing slider apparatus further comprises a connection mechanism, which is configured to selectively set a vertical distance between the slider electrode and the sensing slider electrodes between a first distance and a second distance, wherein the first distance is shorter than the second distance, wherein when the slider is not pressed by the user, the connection mechanism sets the vertical distance as the second distance.

Preferably, in order to prevent the slider frozen in low-temperature weather conditions, wherein the capacitive sensing slider apparatus further comprises a connection mechanism which is configured to selectively couple or decouple the slider and the slider electrode area.

Preferably, in order to save manufacture cost, wherein the sensing slider electrodes of the slider electrode area are collocated in a same layer of multiple first electrodes in parallel to a first axis of a touch panel.

Preferably, in order to reduce the thickness, wherein the multiple sensing slider electrodes and the driving slider electrode are collocated in a same layer.

According to an embodiment of the present application, a touch sensitive processing apparatus applicable to capacitive sensing knob apparatus is provided. The touch sensitive processing apparatus, comprising: an interconnection network module, configured for connecting the multiple first ring electrodes and the second ring electrode; a sensing circuit module, configured for connecting to the first ring electrodes via the interconnection network module; a driving circuit module, configured for connecting to the second ring electrode via the interconnection network module; and a processor module, configured for executing instructions stored in non-volatile memory to realize following steps: having the driving circuit module transmit driving signals to the second ring electrode; having the sensing circuit module sense the driving signals induced by the first ring electrodes to generate sensed values, respectively; calculating an orientation angle of the knob according to the sensed values; and reporting the orientation angle of the knob to a host.

Preferably, in order to calculate the orientation angle of the knob, wherein the calculating step further comprises: finding two largest adjacent sensed values among the sensed values; calculating a ratio of the two largest adjacent sensed values; and calculating the orientation angle of the knob according to the ratio.

Preferably, in order to let the user make the knob as a button, wherein the processor module is further configured for: determining whether a vertical distance between the knob electrode and the second ring electrodes is set at a first distance or a second distance; when it is determined that the vertical distance is set at the first distance, reporting that the knob is being pressed by the user to the host; and when the vertical distance is set at the first distance, reporting that the knob is not being pressed by the user to the host.

Preferably, in order to let the user make the knob as a force sensor, wherein the processor module is further configured for: determining a vertical distance between the knob electrode and the second ring electrodes according to the sensed values; calculating a value of pressure on the knob according to the vertical distance; and reporting the value of pressure to the host.

Preferably, in order to let the touch sensitive processing apparatus more easily to detect the orientation angle of the knob, wherein the processor module is further configured for having the interconnection network connect one or more third ring electrodes to ground potential or a direct current potential.

Preferably, in order to let the user make the knob as a direction button, wherein the processor module is further configured for: having the interconnection network module connect the third ring electrodes, respectively; having the sensing circuit module sense the driving signals induced by the third ring electrodes to generate second sensed values, respectively; and calculating a direction of the knob being pressed according to the second sensed values.

According to an embodiment of the present application, a touch sensitive processing apparatus applicable to capacitive sensing slider apparatus is provided. The touch sensitive processing apparatus, comprising: an interconnection network module, configured for connecting the multiple sensing slider electrodes and the driving slider electrode; a sensing circuit module, configured for connecting the sensing slider electrodes via the interconnection network module; a driving circuit module, configured for connecting the driving slider electrode via the interconnection network module; and a processor module, configured for executing multiple instructions stored in a non-volatile memory to realize following steps: having the driving circuit module provide driving signals to the driving slider electrode; having the sensing circuit module sense the driving signals induced by the sensing slider electrodes to generate multiple sensed values, respectively; calculating a position of the slider based on the multiple sensed values; and reporting the position of the slider to a host.

Preferably, in order to calculate the position of the slider which resides in between two of the sensing slider electrodes, wherein the step of calculating the position of the slider based on the multiple sensed values further comprises: finding two largest adjacent sensed values among the sensed values; calculating a ratio of the two largest adjacent sensed values; and calculating the position of the slider according to the ratio.

Preferably, in order to let the user make the slider as a button, wherein the processor module is further configured for: determining whether a vertical distance between the slider electrode and the sensing slider electrodes is set at a first distance or a second distance; when it is determined that the vertical distance is set at the first distance, reporting that the slider is being pressed by the user to the host; and when the vertical distance is set at the first distance, reporting that the slider is not being pressed by the user to the host.

Preferably, in order to let the user make the slider as a force sensor, wherein the processor module is further configured for: determining a vertical distance between the slider electrode and the sensing slider electrodes according to the sensed values; calculating a value of pressure on the slider according to the vertical distance; and reporting the value of pressure to the host.

Preferably, in order to let the touch sensitive processing apparatus more easily to detect the orientation angle of the knob, wherein the processor module is further configured for having the interconnection network connect one or more third electrodes to ground potential or a direct current potential.

According to an application of the present application, a touch system is provided. The touch system comprising the touch sensitive processing apparatus and the capacitive sensing knob apparatus.

According to an application of the present application, a touch system is provided. The touch system comprising the touch sensitive processing apparatus and the capacitive sensing slider apparatus.

The capacitive sensing knob apparatus and the capacitive sensing slider apparatus provided by the present application remove moving parts for electrically contact. Thus, the apparatuses would not fail due to the wear of the moving parts. Lifetime of these apparatuses can be extended as a result. Besides, the touch sensitive processing methods and apparatus provided by the present application can calculate the orientation angle of the capacitive sensing knob apparatus and the position of the capacitive sensing slider apparatus precisely according to mutual capacitive sensing principles.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A capacitive sensing knob apparatus, comprising:
a knob electrode area, which comprises:
multiple first ring electrodes, which are disposed at a circumference of a first circle evenly, area sizes of each the first ring electrodes are identical, shapes of each the first ring electrodes are similar and pointing to a center of the first circle; and
a second ring electrode, which is disposed at a circumference of a second circle, wherein the first circle and the second circle are concentric circles; and
a knob which is rotatable around the center, wherein the knob comprises a first knob electrode, when the knob is oriented to a first angle, the first knob electrode simultaneously covers parts of the two adjacent first ring electrodes and a part of the second ring electrode.

2. The capacitive sensing knob apparatus of claim 1, wherein the knob electrode area comprises N first ring electrodes, where N is a natural number larger than or equals to 3, where N is a positive integer equals to or larger than 3, wherein when the knob is oriented to the first angle, the first knob electrode simultaneously covers parts of the (N-1) adjacent first ring electrodes and a part of the second ring electrode, one of the first ring electrodes is uncovered.

3. The capacitive sensing knob apparatus of claim 1, wherein when the knob is oriented to a second angle, the first knob electrode simultaneously covers one of the first ring electrodes and a part of the second ring electrode.

4. The capacitive sensing knob apparatus of claim 1, wherein the knob electrode area further comprises one or more third ring electrodes, which are disposed at a circumference of a third circle evenly, wherein the first, the second, and the third circles are concentric circles, a diameter of the third circle is larger than a diameter of the second circle, the diameter of the second circle is larger than a diameter of the first circle.

5. The capacitive sensing knob apparatus of claim 4, wherein the third ring electrodes included in the knob electrode area are disposed at the circumference of the third circle, area sizes of each the third ring electrodes are identical, shapes of each the third ring electrodes are similar and pointing to a center of the third circle.

6. The capacitive sensing knob apparatus of claim 5, wherein when the first knob electrode is pressed, at least one distance between the first knob electrode and one of the third ring electrodes is reduced accordingly.

7. The capacitive sensing knob apparatus of claim 1, wherein a diameter of the first circle is larger than a diameter of the second circle.

8. The capacitive sensing knob apparatus of claim 7, wherein a shape of the second ring electrode is a round pie containing a center of the second circle.

9. The capacitive sensing knob apparatus of claim 7, wherein an area size of the second ring electrode covered by the first knob electrode is identical no matter any orientation angle pointed by the knob.

10. The capacitive sensing knob apparatus of claim 1, further comprises a connecting mechanism which is configured to selectively set a vertical distance between the first knob electrode and the second ring electrode at either a first distance or a second distance, wherein the first distance is shorter than the second distance.

11. The capacitive sensing knob apparatus of claim 1, further comprises a connecting mechanism which is configured to selectively set a vertical distance between the first knob electrode and the second ring electrode between a first distance and a second distance, wherein the first distance is shorter than the second distance, wherein when the knob is not pressed by the user, the connecting mechanism set the vertical distance to the second distance.

12. The capacitive sensing knob apparatus of claim 1, further comprises a connecting mechanism which is configured to selectively couple or to decouple the knob and the knob electrode area.

13. The capacitive sensing knob apparatus of claim 1, wherein the first ring electrodes of the knob electrode area are collocated in a same layer with multiple first electrodes of a touch panel in parallel to a first axis, the second ring electrode of the knob electrode area are collocated in a same layer with multiple second electrodes of the touch panel in parallel to a second axis.

14. The capacitive sensing knob apparatus of claim 1, wherein the multiple first ring electrodes and the second ring electrode are collocated in a same layer.

15. The capacitive sensing knob apparatus of claim 1, wherein the knob further comprises a second knob electrode which is in parallel with the first knob electrode, wherein the second knob electrode is electrically coupled to the first knob electrode, the first knob electrode is closer to the knob electrode area than the second knob electrode.

16. A touch sensitive processing apparatus applicable to the capacitive sensing knob apparatus of claim 1, comprising:
an interconnection network module, configured for connecting the multiple first ring electrodes and the second ring electrode;
a sensing circuit module, configured for connecting to the first ring electrodes via the interconnection network module;
a driving circuit module, configured for connecting to the second ring electrode via the interconnection network module; and
a processor module, configured for executing instructions stored in non-volatile memory to realize following steps:
having the driving circuit module transmit driving signals to the second ring electrode;
having the sensing circuit module sense the driving signals induced by the first ring electrodes to generate sensed values, respectively;
calculating an orientation angle of the knob according to the sensed values; and
reporting the orientation angle of the knob to a host.

17. The touch sensitive processing apparatus of claim 16, wherein the calculating step further comprises:
finding two largest adjacent sensed values among the sensed values;
calculating a ratio of the two largest adjacent sensed values; and
calculating the orientation angle of the knob according to the ratio.

18. The touch sensitive processing apparatus of claim 16, wherein the processor module is further configured for:
determining whether a vertical distance between the knob electrode and the second ring electrodes is set at a first distance or a second distance;
when it is determined that the vertical distance is set at the first distance, reporting that the knob is being pressed by the user to the host; and
when the vertical distance is set at the first distance, reporting that the knob is not being pressed by the user to the host.

19. A touch sensitive processing apparatus applicable to the capacitive sensing knob apparatus of claim 4, comprising:
an interconnection network module, configured for connecting the multiple first ring electrodes and the second ring electrode;
a sensing circuit module, configured for connecting to the first ring electrodes via the interconnection network module;
a driving circuit module, configured for connecting to the second ring electrode via the interconnection network module; and
a processor module, configured for executing instructions stored in non-volatile memory to realize following steps:
having the interconnection network module connect the one or more third ring electrodes to ground potential or a direct current potential;
having the driving circuit module transmit driving signals to the second ring electrode;
having the sensing circuit module sense the driving signals induced by the first ring electrodes to generate sensed values, respectively;
calculating an orientation angle of the knob according to the sensed values; and
reporting the orientation angle of the knob to a host.

20. A touch sensitive processing apparatus applicable to the capacitive sensing knob apparatus of claim 5, comprising:
an interconnection network module, configured for connecting the multiple first ring electrodes and the second ring electrode;
a sensing circuit module, configured for connecting to the first ring electrodes and the third ring electrodes via the interconnection network module;
a driving circuit module, configured for connecting to the second ring electrode via the interconnection network module; and
a processor module, configured for executing instructions stored in non-volatile memory to realize following steps:
having the interconnection network module connect the one or more third ring electrodes to ground potential or a direct current potential;
having the driving circuit module transmit driving signals to the second ring electrode;
having the sensing circuit module sense the driving signals induced by the first ring electrodes to generate sensed values, respectively;
having the sensing circuit module sense the driving signals induced by the third ring electrodes to generate second sensed values, respectively;
calculating an orientation angle of the knob according to the sensed values;
calculating a direction which the knob being pressed according to the second sensed values; and
reporting the orientation angle of the knob and the direction to a host.

21. A touch system, comprising:
the touch sensitive processing apparatus and the knob electrode area as recited in claim 16.

22. A touch system, comprising:
the touch sensitive processing apparatus and the knob electrode area as recited in claim 19.
